(19) United States
(12) Patent Application Publication
(10) Pub. No.: US 2005/0192930 A1
(43) Pub. Date: Sep. 1, 2005

(54) System and method of real estate data analysis and display to support business management

(75) Inventors: Steven Hightower, Glen Ellen, CA (US); William D. Biggs, Santa Rosa, CA (US); Timothy Frazer, Glen Ellen, CA (US); Peter Krause, Glen Ellen, CA (US); Eric Biggs, Santa Rosa, CA (US)

Correspondence Address: COATS & BENNETT, PLLC, P O BOX 5, RALEIGH, NC, 27602, US

(73) Assignee: Terradatum, Inc.

(21) Appl. No.: 11/065,893

(22) Filed: Feb. 25, 2005

Related U.S. Application Data
(60) Provisional application No. 60/548,220, filed on Feb. 27, 2004.

(51) Int. Cl. G06F 7/00

(52) U.S. Cl. 707/1

(57) ABSTRACT

A suite of software tools performs data mining on data periodically extracted from one or more Multiple Listing Service (MLS) databases to support the management of a real estate business. Data relating to properties listed or sold by units of the business, such as agents, offices, regions, or the entire business, are extracted and aggregated at each hierarchical level. Novel performance metrics are defined, calculated, tracked and displayed in a consistent manner across hierarchical levels. The similarity of views of the data facilitate communication across organizational levels and support improved productivity. The tools may access MLS-derived real estate data associated with other properties to perform market analysis—including both market share by selected competitors and overall market trends—to support pricing of properties, and to discover and recruit high performance personnel.

### RELATED APPLICATIONS

This application claims priority to Provisional U.S. Patent Application 60/548,220 filed Feb. 27, 2004, which is incorporated herein by reference in its entirety.

### BACKGROUND

The present invention relates generally to the field of software and in particular to software products that provide statistical analysis and display of real estate data to support improved and efficient management of real estate businesses.

Advances in information technology have revolutionized business management practices in industries across the spectrum. However, the buying and selling of real estate remains largely a face-to-face operation. Additionally, the management of real estate businesses—from individual agents to national real estate enterprises comprising thousands of real estate offices—has been slow to embrace advanced information technology systems and methodologies to increase efficiency and better manage the business.

Paradoxically, the real estate industry is among the oldest of businesses to rely to a significant extent on an extensive, richly populated database—the Multiple Listing Service (MLS). As is well known in the art, the MLS database includes a wide variety of information related to listings, or properties for sale. The data include, for example, the type of property, the features of the property, its location, the asking price, the listing agent/broker, and the like. Additionally, the MLS includes data related to the sale of the property, such as the date of contract, the date of closing, the sale price, the selling agent/broker, and the like.

While virtually all real estate businesses subscribe to the MLS, and utilize the database in the day to day operation of the business, MLS data is not utilized by real estate business managers to generate strategic plans, set goals, define and track measures of progress and business efficiency, evaluate performance, and the like, of their own businesses. That is, real estate businesses primarily utilize MLS to list their own properties, and to discover and analyze properties listed by others.

It is known in the art for agents and brokers to utilize MLS data in a rudimentary manner to assist in pricing properties. MLS data is also utilized by facilities management personnel to perform comparative analyses of selected properties, for tax purposes, assessments, determination, to inform investment decisions and the like. It is also known to perform statistical analysis on aggregate MLS data to forecast projected housing needs for planning and urban development, and the like. However, no prior art MLS data analysis systems or methods utilize advanced data mining, statistical analysis and sophisticated display views to provide powerful tools to facilitate and improve the management of real estate businesses.

### SUMMARY

In one embodiment, data periodically extracted from the Multiple Listing Service (MLS) database is mined to support the management of a real estate business having a hierarchical management structure and including a plurality of units, which may comprise regional divisions, real estate offices, or real estate agents. Real estate data are periodically extracting from one or more MLS databases to a local database. Only the data associated with properties listed or sold by the real estate business are aggregated at one or more hierarchical levels of the business, and displayed in a format that is consistent across the levels.

Another embodiment relates to a method of managing a real estate business comprising a plurality of units. Real estate data are periodically extracted from one or more Multiple Listing Service (MLS) databases to a local database, and data associated with properties listed or sold by the units are extracting from the local database. Data associated with a first unit are displayed in a first display on a first terminal. A list of the units is displayed on a second terminal. Data associated with the first unit is selectively displayed in a second display on the second terminal in response to a user selecting said first unit from the list, wherein the first and second displays display the same data in substantially the same way.

Another embodiment relates to a method of ascertaining real estate market trends. Real estate data are periodically extracted from one or more Multiple Listing Service (MLS) databases to a local database. A market is defined by selecting one or more property attributes, including MLS-defined geographic area. Data associated with properties in the market is extracted on an ad hoc basis form the local database. The data are analyzed to calculate predetermined market metrics. The value of at least one such metric over a predetermined time period is displayed in a table or graph.

Another embodiment relates to a method of evaluating a real estate agent not associated with a real estate business. Real estate data are periodically extracted from one or more Multiple Listing Service (MLS) databases to a local database. Data associated with properties listed or sold by said real estate agent over a predetermined time period are extracted from the local database. The data are analyzed against financial and performance metrics unique to the real estate business, and information estimating what the real estate agent's performance would have been within the real estate business over the time period is displayed.

Another embodiment relates to a method of determining a listing price for a subject property. Real estate data are periodically extracted from one or more Multiple Listing Service (MLS) databases to a local database. One or more attributes of the subject property obtaining are obtained. Data associated with properties having similar attributes are extracted from the local database. A graph depicting the number of similar properties listed and sold over a predetermined time period and the number of currently active listings of similar properties is displayed. In a further embodiment, a scatterpoint graph of similar properties falling within a selectable range of the subject property price is displaying, the graph having an ordinate representing days on market and an abscissa depicting price.

Another embodiment relates to a method of assessing real estate market share. Real estate data are periodically extracted from one or more Multiple Listing Service (MLS) databases to a local database. A market is defined by identifying attributes including MSL-defined geographic area. Competitors are defined by identifying one or more real estate offices or brokers. Data associated with properties in the market, listed or sold by the competitors, are extracted from the local database. The relative share of the market held by each competitor is calculated and displayed.

### BRIEF DESCRIPTION OF DRAWINGS

FIG. 1 is block diagram of a hierarchical real estate enterprise.

FIG. 2A depicts an information display screen for a higher hierarchy manager, in particular a higher level Production view.

FIG. 2B depicts an information display screen for a lower hierarchy unit, in particular a lower level Production view.

FIG. 3 depicts an enterprise Status view.

FIG. 4 depicts an enterprise level Office Analysis Overview view.

FIG. 5 depicts an enterprise level Inventory view.

FIG. 6 depicts an enterprise level Office Analysis Inventory view.

FIG. 7 depicts an enterprise level Office Analysis Measure view.

FIG. 8 depicts an enterprise level Office Analysis Monitor view.

FIG. 9 depicts a view of Sold Listings—Median Price.

FIG. 10 depicts a view of Active Listings vs. Sold Listings—Units.

FIG. 11 depicts a view of Active Listings vs. Accepted Offers—Units.

FIG. 12 depicts a view of Months Supply of Inventory (MSI) vs. Median Days on Market (DOM).

FIG. 13 depicts a view of Percentage: Accepted Offers to New Listings.

FIG. 14 depicts a view of Median Sold Price vs. DOM.

FIG. 15 depicts a view of New Listings vs. Accepted Offers—Units.

FIG. 16 depicts a view of Active Listings vs. Expired Listings—Units.

FIG. 17 depicts a view of New Listings vs. Active Listings—Units.

FIG. 18 depicts a view of New Listings vs. Sold Listings—Units.

FIG. 19 depicts a view of Percentage: Accepted Offers to Active Listings.

FIG. 20 depicts a view of Active Listings—Median Price.

FIG. 21 depicts a view of Accepted Offers—Median Price.

FIG. 22 depicts a view of New Listings—Median Price.

FIG. 23 depicts a view of Expired Listings—Median Price.

FIG. 24 depicts a view of Combined (A,S,X) Median Prices.

FIG. 25 depicts a view of Pricing Analysis—Price Distribution.

FIG. 26 depicts a view of Pricing Analysis—Pricing Window.

### DETAILED DESCRIPTION

In one or more embodiments, the present invention comprises an integrated software suite of ad hoc data mining and analysis tools, incorporating a novel, intuitive display and user interface, to facilitate and improve the management of real estate businesses. The tools operate consistently at the level of an individual agent, a real estate office comprising a plurality of agents, a regional conglomerate of real estate offices, and a national or international enterprise of real estate offices. The primary database accessed by software according to one or more embodiments is the Multiple Listing Service (MLS) of the real estate industry. While real estate businesses traditionally use the MLS to advertise properties for sale and to search for properties to buy, one or more embodiments disclosed herein mines, analyzes and aggregates data from the MLS related to a real estate business's own listings, to provide valuable information to promote efficiency and facilitate goal-oriented management techniques for the business executives.

Extensive data are periodically (e.g., daily) extracted from the MLS, and maintained in a local database. This local database is accessed to extract, aggregate and analyze data in support of real estate business management. The local database assures availability and high-speed access to the relevant data. Storing the data locally additionally allows for tracking certain information over time for which historical data is not retained in the MLS database, such as all modifications to the listing price of a property.

A significant feature of one or more embodiments is the ad-hoc availability of information. Services known in the art extract data from the MLS, and provide, e.g., monthly views of overall market trends, such as the average price of certain classes of properties or the like. These analyses are inherently historic, packaging and presenting data from the previous month or quarter. The displays are static, comprising printed charts and graphs. In contrast, the aggregation and analysis of data according to embodiments of the present invention is performed on an ad hoc basis—at the user's request. The local database is routinely updated (e.g., daily), so the information is always recent, although it may not be strictly “real-time.” As used herein, the term ad hoc means impromptu, or at the user's whim, accessing recent data.

A list of terms and abbreviations having particular meaning herein include:

Agent—Real estate agent or broker, whether Listing or Selling.

C/L—Closed to Listed Ratio

T/L—Transactions to List Ratio

List Side or List—Properties for which the agent or broker represented the seller (i.e., listed the property in the MLS). May be listed as a number or by dollar volume.

Sell Side or Sell—Properties for which the agent or broker represented the buyer (i.e., caused the listed property to be sold). Also known in the art as the Buy Side. May be listed as a number or by dollar volume.

Listed—all properties for sale during a specified duration. These may be further classified as: Active (A), Sold (S), Expired (X), Withdrawn (W) or Temporarily-Off-Market (T). May be listed as a number or by dollar volume.

SOC—Selling Office Commission or Selling Office Compensation (often listed as %). The SOC is a not publicly known, but may be inferred in one or more embodiments from analysis of sales data.

GCI—Gross Commission Income or Gross Company Income

DOM—Days on Market

DUC—Days Under Contract

DCC—Desk Cost Coverage; annual expenses divided by twelve divided by the number of “desks,” or agents and associates. The DCC is calculated over four seasons to remove seasonal market dependencies.

DE %—Double-Ended Transactions, as a percentage

Ad$/C—Advertising costs per closing

AMT—Average Marketing Time

SP/OP—Selling Price divided by Original Price

PR—Price Reductions

PR/L %—Percentage of Listings with Price Reductions

Ratified Listing—A listing for which an offer has been accepted.

ROR—Return on Revenue; the amount of agent GCI retained by the broker.

YTD—Year to Date

QTD—Quarter to Date

MTD—Month to Date

### Hierarchical Real Estate Business

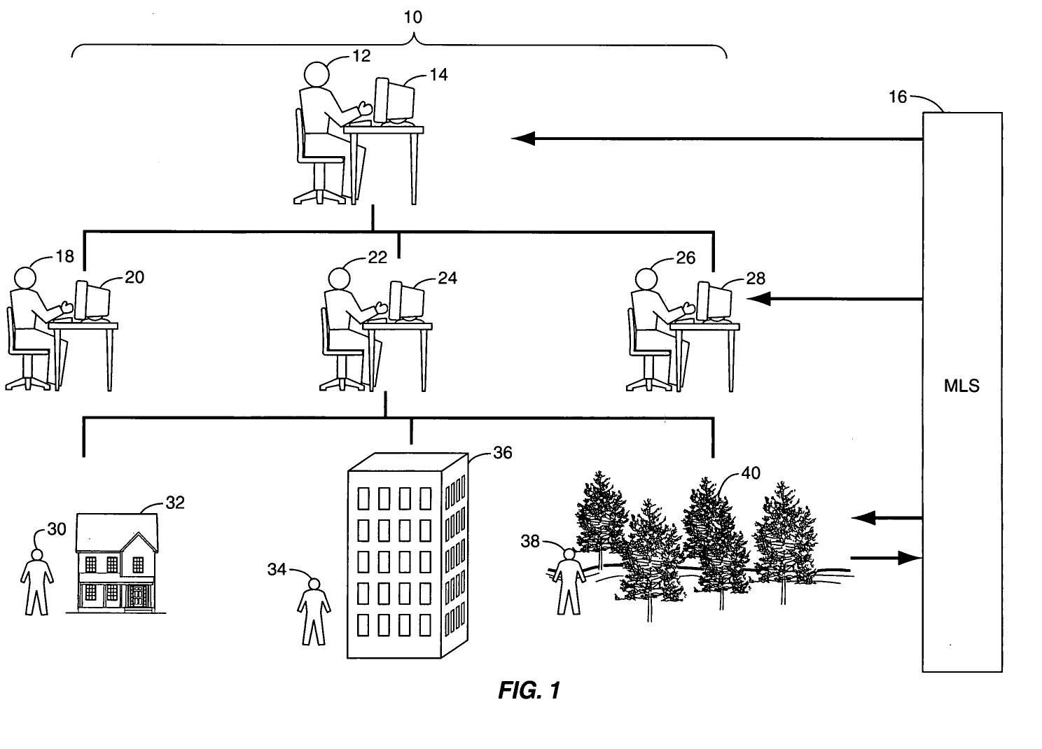

FIG. 1 depicts an organizational diagram of a real estate business having a hierarchical management structure and including a plurality of units. In one embodiment, a regional or national real estate enterprise 10 comprises an enterprise level manager 12 viewing data displayed on a terminal 14, such as a personal computer. The enterprise level manager 12 views various aggregations and displays of data extracted from the MLS database 16 that relate to properties listed or sold by the enterprise as well as by functional units the real estate business 10, such as individual real estate offices within the enterprise 10 and individual real estate agents 30, 34, 38. This organizational level is referred to herein as the enterprise level. The view of FIG. 1 is functional; in any given embodiment, the MLS database may not be a single entity (particularly at the enterprise level), but may comprise an aggregation of a plurality of regional MLS databases. Additionally, FIG. 1 does not depict the local database that resides between the MLS database and the users.

At a hierarchical level below the enterprise level manager 12 are a plurality of real estate office managers 18, 22, 26, each viewing data displayed on terminals 20, 24, 28, respectively. These terminals 20, 24, 28 each display various aggregations and displays of data extracted from the MLS database 16 that relate to properties listed or sold by the respective real estate office. This organizational level is referred to herein as the office level.

At a hierarchical level below the each real estate office manager 18, 22, 26 are a plurality of real estate agents 30, 34, 38 (only agents 30, 34, 38 managed by the real estate office manager 22 are depicted in FIG. 1). The agents 30, 34, 38 list and sell a variety of properties through the MLS system, such as residential properties 32, commercial properties 36 and unimproved properties 40. The agents 30, 34, 38 cause alterations in the MLS database 16 by virtue of their listing and selling activities. In addition, according to one or more embodiments, the agents 30, 34, 38 may extract and view various aggregations and displays of data extracted from the MLS database 16 that relate to properties that the individual agents 30, 34, 38 have listed or sold. This organizational level is referred to herein as the agent level.

Those of skill in the art will recognize that FIG. 1 is representative only, and that a given real estate business 10 may include more or fewer levels of hierarchy, and any number of units at each hierarchical level. For example, a plurality or regional managers (not shown) may be interposed between the enterprise level manager 12 and the real estate office managers 18, 22, 26. Alternatively, the entire real estate business 10 may comprise only one level of hierarchy, such as a single real estate office. In addition, the depicted functional division between agents 30, 34, 38 and real estate office managers 18, 22, 26 is not limiting. For example, one or more real estate office managers 18, 22, 26 may be a broker who himself or herself lists and sells properties 32, 36, 40, and hence alters the MLS database 16.

### Consistent User Interface over Plural Levels of Aggregation

A significant feature of one embodiment is similar functionality and a consistent user interface across multiple hierarchical levels of operation, such as for example, agent, office, regional, and enterprise. An individual may utilize this embodiment to analyze and track his or her own listings, define personal performance metrics and measure and track performance against them over time, define and track efficiency metrics to improve his or her efficiency, as well as traditional uses of MLS data such as to publish listings, locate listed properties according to various criteria, and the like.

A manager of a real estate office comprising a plurality of real estate agents may utilize an embodiment in a similar fashion, aggregating data relating to all agents in the office to track and improve overall office efficiency and productivity. In many displays of aggregate data, the office manager has the ability to “dive down” into the data, to view detailed information pertaining to an individual agent, listing, or other relevant subset of the aggregate data.

The office manager's view of the aggregate data, and the user interface that allows for manipulation of the data, parallels the display and user interface of the agent level tools. That is, the various “views” of aggregate data presented to the office manager utilize the same or similar displays (tables, graphs, icons and the like) and user interface as those presented to the individual agents using the agent level of aggregation. This consistency of display and user interface at the different functional levels reduces training time and costs, facilitates communication throughout the office, and facilitates the management functions of the office.

In particular, the consistent display and user interface facilitates a methodology whereby the office manager defines metrics of performance and efficiency, sets goals for the office and for individual agents, communicates those goals to the agents, and tracks both the office's and the agents' progress over time. Simultaneously, the agents may utilize an embodiment, enhanced by the consistent display and user interface between the office and agent levels, to monitor and track their own efficiency, productivity, and the like, against goals set by the office management and/or by the agents themselves.

Similarly, one or more embodiments aggregate data from a plurality of offices, to facilitate and support the business management of a regional real estate enterprise or regional division of a national or international real estate business enterprise. The display and user interface of the regional level aggregation of data, according to one embodiment, is directly analogous to that at the office and agent level. The regional level also supports diving down into aggregated data to view information related to individual offices. In one embodiment, the regional manager may configure the software tools to display and manipulate the office level or agent level tool. That is, each hierarchical level of aggregation includes, and is a superset of, the entire functionality of lower levels of aggregation. Additionally, a regional manager may dive down into office or agent level information directly, i.e., switching the entire regional level interface to that of the office level or agent level is not required.

In one embodiment, a national level set of views aggregates data from two or more regional companies or divisions, or from a large plurality of real estate offices. As described above, the display of information and user interface at the enterprise level parallels that at each of the lower levels, and includes both the functionality of all lower levels and the ability to directly dive down to access information at any desired level of aggregation. In general, any number of hierarchical levels of aggregation of information may be generated, to support a variety of business models.

In a presently preferred embodiment, functionality is configured and distributed separately by level. That is, the agent level functionality is sold as a stand-alone application, such as AgentMetrics™ software available from Terradatum Corporation. The office level functionality is similarly available as a stand-alone application, such as the BrokerMetrics-Office™ product, also available from Terradatum Corporation. As described above, the office level product includes the functionality of the agent level product. The enterprise level functionality is configured as a stand-alone product, such as the BrokerMetrics-Enterprise™ application available from Terradatum Corporation. The regional level of functionality is available as an optional module associated with the BrokerMetrics-Enterprise™ product. In the following discussion, an enterprise/office/agent hierarchy is assumed; however, a regional level may be included, as well as other configurations.

Preferably, according to one or more embodiments, each level of aggregation includes a suite of views displaying information pertaining to one unit of each lower hierarchical level. For example, the enterprise level includes a plurality of views of data aggregated across all listings and sales by the entire enterprise. Additionally, the enterprise level includes a suite of views wherein the data displayed is extracted only from one office. In the BrokerMetrics-Enterprise™ product, this functionality is referred to as Office Analysis. Similarly, the office level aggregates data from all agents in the office. Additionally, the office level includes a suite of views wherein the data displayed is related only to one agent. In the BrokerMetrics-Office™ product, this functionality is referred to as Agent Performance.

However, the present invention is not limited to configuration and distribution according to this model. As those of skill in the art will recognize, many models of distribution and access control, as known in the art, are readily applicable. For example, all four levels of functionality may be included in a single application with varying levels of access control implemented through separately sold passwords or the like. Alternatively, the various levels of aggregation may be mixed and matched in one or more separate applications, as necessary or desired. These configurations, like many aspects of the software, may be dynamically changed. In one or more embodiments, upon launching and prior to accessing a real estate database, the software checks to ascertain if an updated version is available, such as via an internet connection on the terminal launching the software. If an updated version is available (optionally, within the scope of the user's license), the software is updated “on the fly” prior to fully loading and accessing the real estate database.

Note that while one or more embodiments are described herein with all “views” of the data available at each level of aggregation, this functionality could additionally be included or excluded from any given implementation. Thus, not all data views, displays, or functionality of the each embodiment need necessarily be present in every implementation falling within the scope of the invention.

A useful feature of one or more embodiments is that the lower-level, unit-specific views at the higher level are directly analogous to the aggregate views at the corresponding lower level. Thus, for example, an enterprise level manager 12 viewing a specific office's data would encounter displays and user interfaces directly analogous to what the relevant office manager 18, 22, 26 viewing his aggregate office data would see.

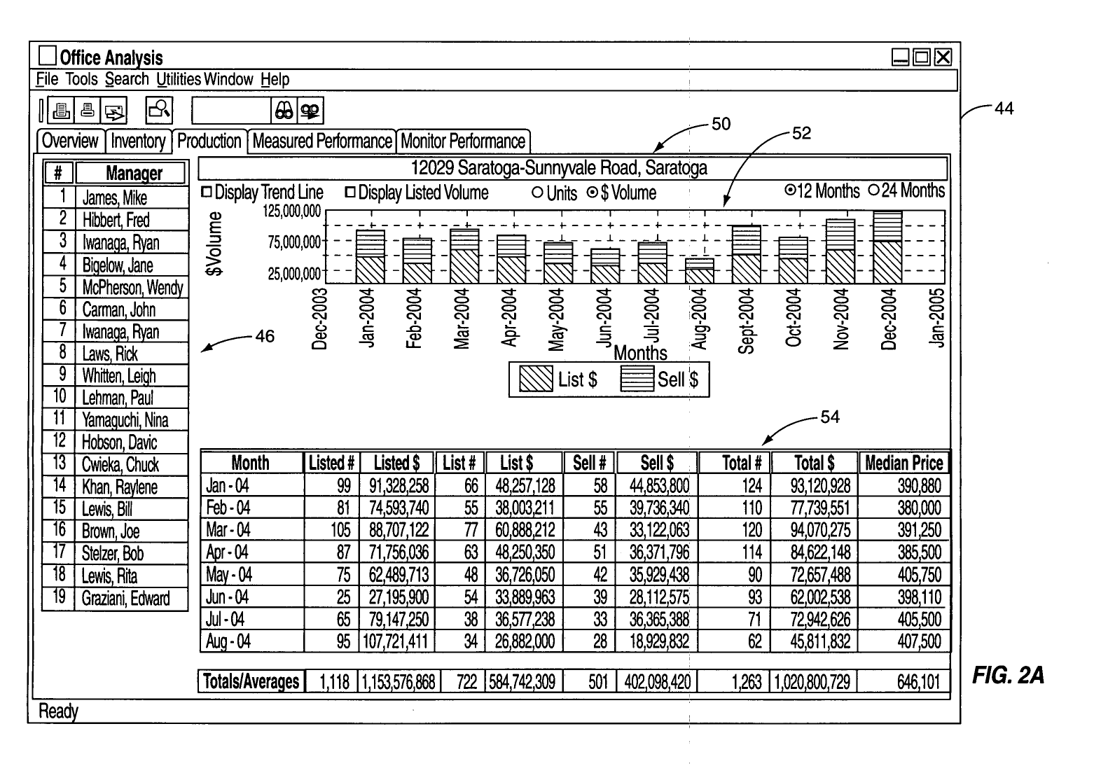

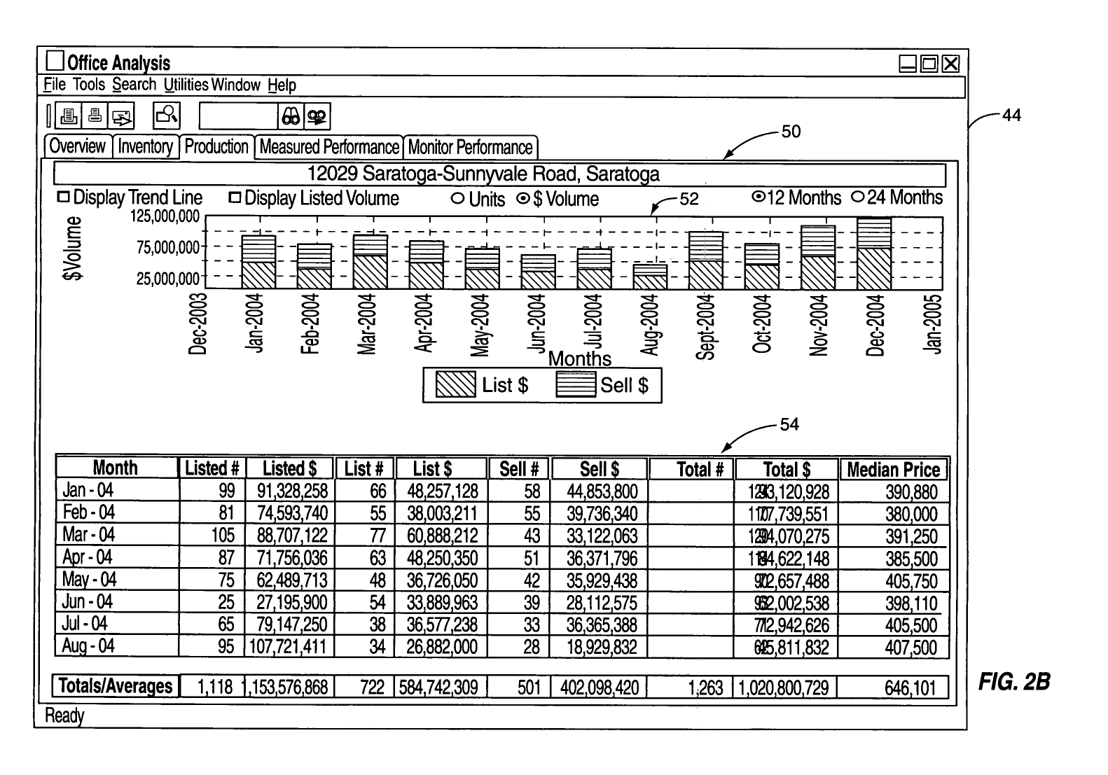

For example, FIG. 2A depicts a higher-level display 42, and FIG. 2B depicts a corresponding lower-level display 44. The display 42 may, for example, be displayed at the terminal 14 of an enterprise manager 12. Correspondingly, the display 44 may be displayed at the terminal 24 of an office manager 22. The higher-level display 42 includes an Office Grid, or selection list, 46 and an information window 48. The display 44 includes only an information window 50, and does not include the Office Grid 46. The information window 48 differs from the information window 50 only in size—the information windows 48, 50 display identical information in an identical manner, which may include tabular displays and/or a variety of graphical displays. For example, FIGS. 2A and 2B depict a Production display (explained further herein) for a particular office, which includes a bar graph 52 depicting listing and sold properties, and a tabular textual display 54 depicting information underlying the graph 52.

In practice, an enterprise manager 12 may bring up the display 42, select a first office from the Office Grid 46, and place a telephone call to the office manager 22 of that first office, who brings up display 44. The managers may then discuss the business and productivity metrics of the first office, for which the office manager 22 has responsibility. As the managers 12, 22 discuss various aspects of the office's performance, they may each bring up information views on their respective terminals 14, 24 (such as Status, Inventory, Production, Measure and the like, as discussed further below). In each such case, the display 48 seen by the enterprise manager 12 and the display 50 seen by the office manager 22 are substantially identical. This consistency of user interface and view into the same information dramatically facilitates and enhances communications between the managers 12, 22.

After such a discussion, the enterprise manager 12 may select a second office from the Office Grid 46, changing the information displayed in display 48 to that associated with the second office. The enterprise manager 12 may then call the second office's manager 26, and discuss that office's business and performance metrics. The second office's manager 26, viewing the display 44 on his terminal 28, then has the same information before him, displayed in the same manner, as the enterprise manager 12, thus facilitating communications between the two. In this manner, the enterprise manager 12 may quickly review the performance of all offices for which he has responsibility, and may have efficient, focused conversations with office managers 18, 22, 26, facilitated by the consistency of views into the MLS data associated with each office's properties. This capability avoids the frustration, confusion and general inefficiency of different hierarchical levels of the organization “talking past” each other as they view different data and/or different depictions of the same data.

The same consistency of user interface and information display across hierarchical levels is present between an office manager 22 and real estate agents 30, 34, 38, and the same benefits of effective communication and efficient management accrue. In that case, the display 42 may be displayed by an office manager 22 on a terminal 24, and the display 44 may be displayed by a real estate agent 34 on a terminal (not shown).

An additional benefit to this consistency of views across hierarchical levels is career development. As individuals are promoted to higher hierarchical levels within the enterprise, for example from agent 30, 34, 38 to office manager 18, 22, 26; from office manager 18, 22, 26 to regional manager 12; or the like, the tools with which they will measure and evaluate the units for which they have responsibility are identical to the tools they have previously used to manage their own productivity. This consistency of views, as well as the power of data mining the MLS, thus reduces training time and expense, and increases productivity as individuals are promoted within the organization.

### Status View

One embodiment includes a status view of information relevant to the business. The status view may be selected within an application or level of aggregation, such as by selecting a tab. This view provides “big picture,” critical information in limited detail.

### Status View—Enterprise Level

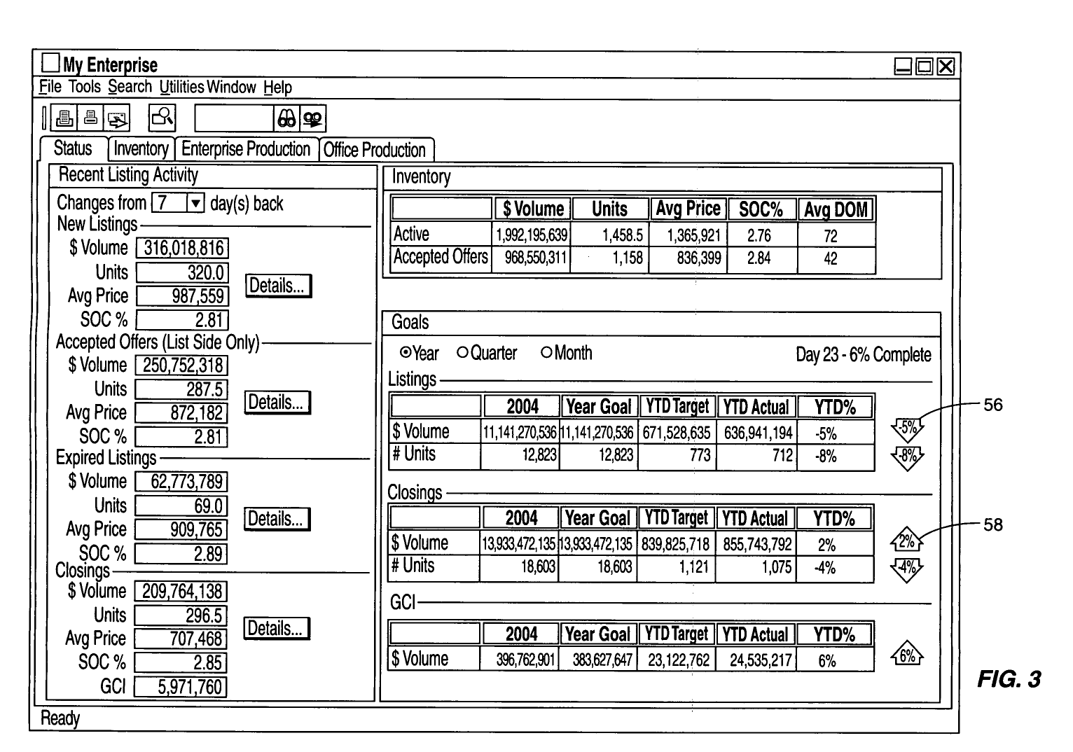

The enterprise level in one embodiment presents a Status view of information extracted from the MLS database, as depicted in FIG. 3. The Status view may include a Recent Listing Activity display, wherein the duration of “recent” is selectable (either by entering a number or by selecting one from a drop-down list). The Recent Listing Activity may display the total dollar volume, number of units, average price, and average commissions for new, ratified and expired listings, and closings.

The user may “dive down” into the underlying data aggregated to produce these summaries, for example, by clicking on the Details button. This may open a display of information for the relevant category, which may include the office manager's name, office name, office address, number of listings, dollar volume, average price, SOC %, and for closings, GCI for each office aggregated to the Recent Listing Activity display. This information may be displayed in tabular format, for example in a new window. As known in the software arts, the table may be sorted by the contents of any column. The details window may additionally include an export button for generating files or printouts of the information. A selected row of the table, representing a particular real estate office, may itself be “dived down” into, to display, for example, the individual listings by that office, including relevant information such as address, type, list price, and the like. A user may dive down into a selected listing, opening a window that contains the full, detailed MLS information for that listing.

An Inventory display of the enterprise level Status view may display an overview including one or more of the current dollar volume, number of units, average price, SOC %, and average number of days on market for active and ratified listings, preferably as a two-row table.

A Goals display may present actual performance versus goals in three categories—listings, closings, and GCI—compared to predetermined goals for each of a plurality of durations, such as YTD, QTD and MTD. The previous year's actual figures for the corresponding time period may additionally be displayed, for reference or comparison. A novel and highly useful feature of the goals display is an iconic representation 56, 58 of whether the actual figures exceed or fall short of the goal. In one embodiment, a prominent green arrow icon 58 pointing up may indicate a parameter for which the enterprise is currently exceeding goals. A visible red arrow icon 56 pointing downward may indicate parameters for which the enterprise is currently falling short of goals. The percentage difference versus the goal may be superimposed on the respective icons. A counter may show the amount of the current selected time period—such as YTD, QTD or MTD—that has passed, such as in number of days and as a percentage of the selected duration. In one embodiment, the goals used in the calculations may be based on a zero percent increase over the previous year's actual figures.

### Status View—Enterprise Level, Office Analysis View

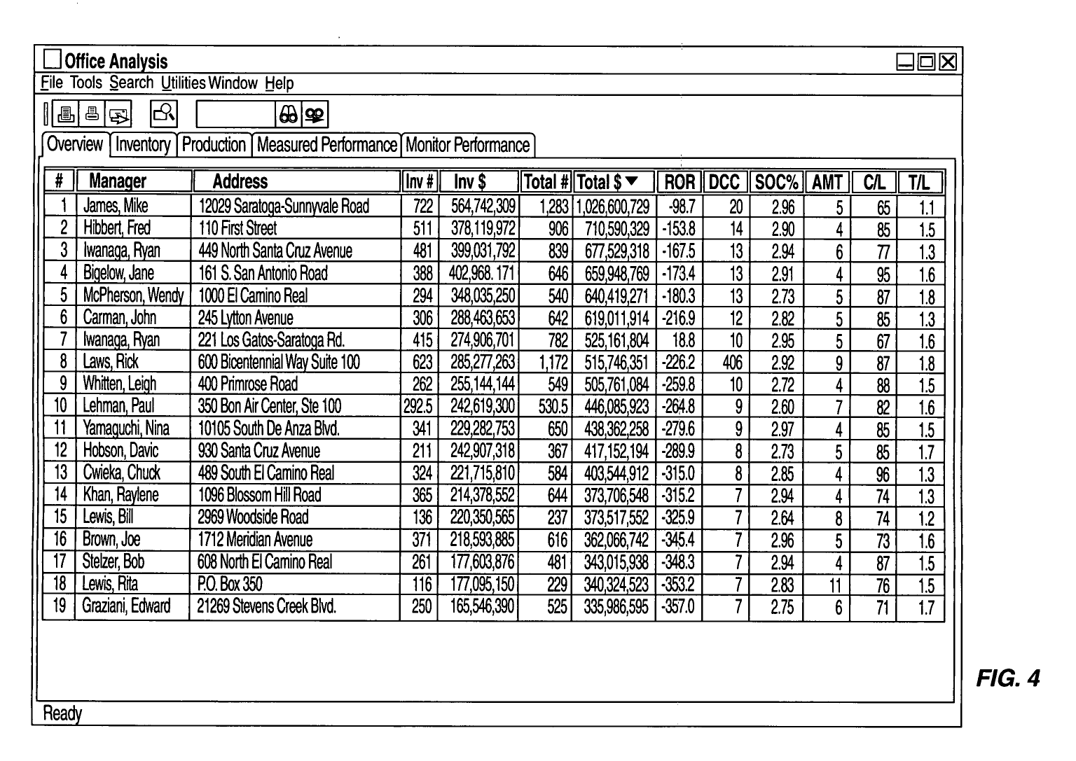

The Office Analysis Status (or Overview) view according to one embodiment provides the enterprise (or regional) level manager with a list view of relevant information and performance metrics for each office within the enterprise. The list may be a tabular display, one office per row, as depicted in FIG. 4. The data displayed for each office may include one or more of: a numeric ranking (initial sorting of the display is according to this ranking); office manager; office address; inventory and total transactions by number and dollar volume; and a plurality of performance metrics such as SOC %, C/L, AMT, T/L, Ad$/C, DE % and SP/OP %. The table may include dive down capability to access more information related to each office.

### Status View—Office Level

The office level according to one embodiment presents a status view of information relevant to the business metrics of an individual real estate office. The status view may also be referred to as a Hotsheet. The Hotsheet provides a “big picture” view of recent listings, offers, transactions and the like to support the office manager. The Hotsheet may display, for example, New Listings, Accepted Offers, Expired Listings, and Closings. Each of these displays may be a tabular display, comprising one property per row, with the columns providing relevant information such as address, property type, price, SOC, the listing agent, information regarding the property such as number of bedrooms, baths, square footage, and the like, and similar relevant information. The tables are preferably confined to predetermined areas of the display and scrollable in the event that the table exceeds the allocated display space. Each of the tables may include dive down capability, such as by selecting an associated mouse button. This may open a new window containing the full tabular data, with export functionality. The duration over which information is displayed in the four tables may be selectable, such as by entering a number or selecting a number from a drop-down list, over a predetermined range, such as from 1-31 days previous.

The Hotsheet view may additionally include summary Inventory and Goals displays. The inventory display may comprise a tabular display comprising two rows, Active Listings and Accepted Offers. Each of these rows may display associated data in columns, such as the total number of listings, total dollar volume of listings, average list price, average listing dollar volume per agent, and average DOM. The Goals display may also comprise a two-row tabular display. The metric to which the Goals display is directed may be selectable, such as between Listings, Closings and GCI. The goals may be selected from a drop-down list. The time frame of the information displayed may be selectable from among predetermined values, such as YTD, QTD and MTD, which may be selected via a drop-down list. The Goals display may include an indicator of the current temporal position within the selected time frame, in terms of the day count and percentage completion. For each goal metric selected, the Goals display may comprise a tabular display of information in two rows, Total Number and Total Dollar Volume. The columns may include one or more of: the relevant time period for the previous year, the office production goal for the current selected time period, the office production target for the current selected time period, the actual office production for the current selected time period, and the amount, expressed as a percentage, that the actual production is over or under the target. The percentage display may be augmented with iconic displays, which are may be color-coded according to the value of the displayed percentage. For example, positive values (representing actual production exceeding targeted production) may be displayed as green icons, and negative values (indicating actual office production falling short of targeted production) may be displayed as red icons. The icons may additionally include visual indicators, such as a checkmark for the green icons and a minus sign, exclamation point, or the like for the red icons. Alternatively, the icons may include indicative shape and/or orientation, such as a green arrow pointing up for positive data, and a red arrow pointing down for negative data.

### Status View—Office Level, Agent Performance View

In one embodiment, the office level Agent Performance Status (or Overview) view may comprise a tabular list of all office agents and their related information and performance metrics. The view is directly analogous to the enterprise level Office Analysis Status (or Overview) view of FIG. 4. The table may list, for each agent, one or more of: a numeric ranking; the agent's name; inventory and total transactions by number and dollar volume; SOC %, C/L, AMT, T/L, Ad$/C, DE % and SP/OP %. The table may support dive down capability to access more detailed agent information.

### Inventorv View

In one embodiment, an Inventory view of information related to properties listed by the business may be provided. The Inventory view may be selected within an application or level of aggregation, such as by selecting a tab. This view provides detailed information about the business's listings, including a novel listing aging display that assists managers in quickly identifying properties that are not selling in a timely manner.

### Inventory View—Enterprise Level

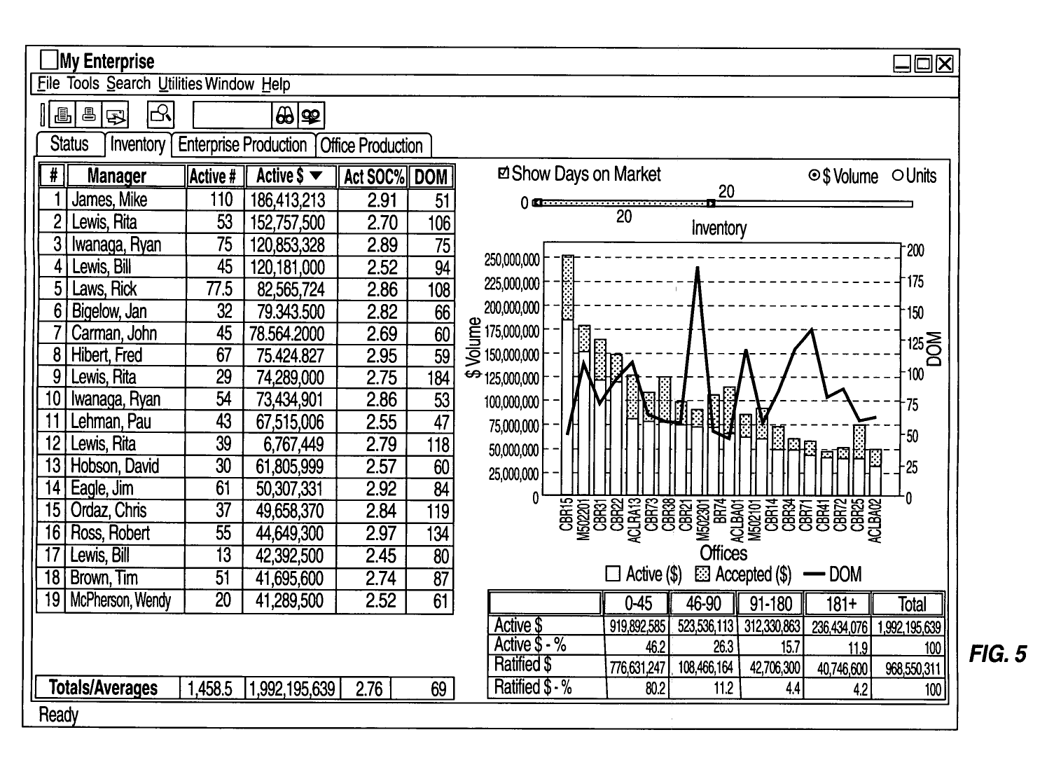

The enterprise level may present an Inventory view of aggregated information for active and ratified listings for the offices within the enterprise, extracted from the MLS database, as depicted in FIG. 5. This view preferably comprises both a tabular and stacked graph displays, which are linked together. The tabular display, referred to as the Office Grid, shows each office within the enterprise (one per row), and may include one or more of the office manager's name, the number of active listings, the dollar volume of active listings, the SOC %, and the average DOM for each office. The table may also display the rank of each office, and may initially be sorted by this rank. In one embodiment, the Office Grid may be sorted according to any column, and the tabular display may include shadings to visually differentiate rows. The user may dive down to view the either information related to the selected office, or a table of the listings of that office. The user may dive down into the listings of that table, to view information related to each listing.

Concurrently with the tabular display, a graph depicting the inventory for each office may additionally be displayed. The graph is preferably a stacked bar graph depicting both active and accepted listings by volume. A line graph of average DOM may be selectively superimposed on the bar graph. The units of the bar graph displays may be selectable between, for example, dollar volume and number of units, such as by selecting radio buttons. The offices displayed in the bar graph may be controlled by a double-ended slider bar. The number of offices displayed may be adjusted between one and up to all offices by stretching the slider bar relative to the extent of a slider bar channel. Which offices are displayed in a given bar graph is controlled by moving the slider bar along the slider bar channel. The tabular Office Grid and graphic bar graph displays are linked. Positioning the cursor over a bar in the bar graph display highlights the corresponding office in the Office Grid. Additionally, a mouse-over pop-up feature may display numeric data relative to the selected bar (e.g., the bar under the cursor position).

A novel inventory display is an Inventory Aging Grid that displays the total volume of active and ratified listing grouped by DOM, such as in predetermined durations, such as 0-45 days, 46-90 days, 91-180 days, 181+ days, and total. This display provides a quick view of the relative ages of an enterprise's listings. The inventory aging data may be displayed, in each duration segment, as total dollar volume, percent of total inventory, or both. The data displayed in the Inventory Aging Grid may be an aggregate of all of the offices in the enterprise. A more detailed view of the Inventory of each office is presented by the enterprise level Office Analysis Inventory View.

### Inventory View—Enterprise Level, Office Analysis

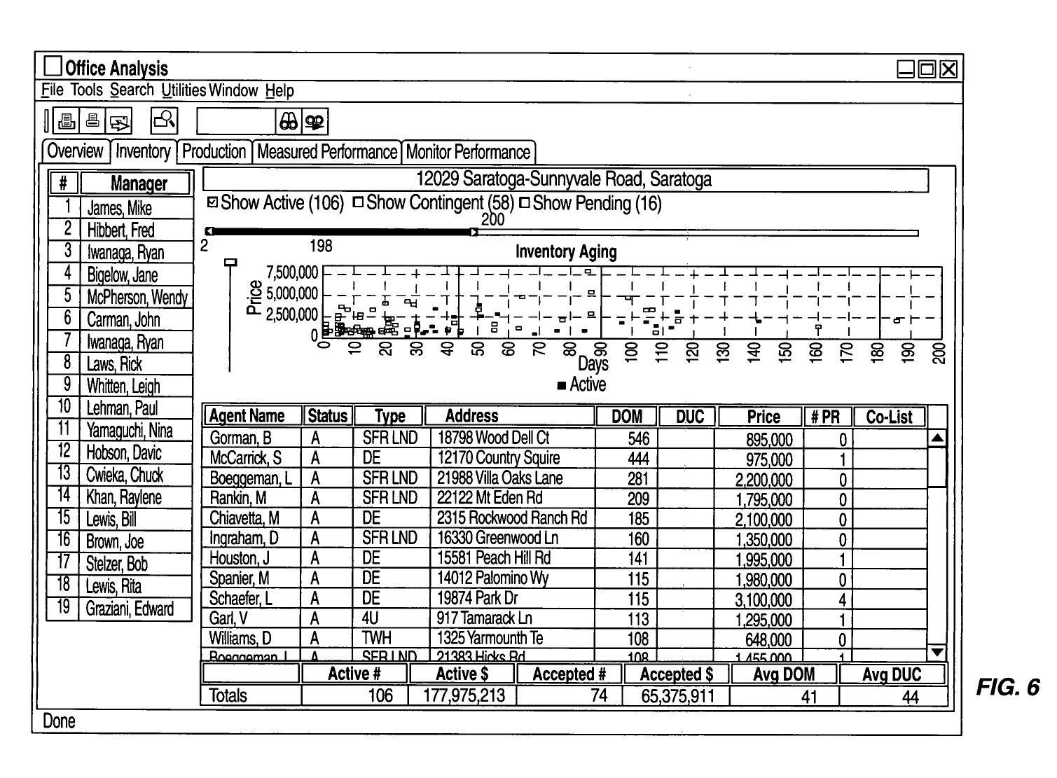

In one embodiment, the Office Analysis Inventory view provides the enterprise (or regional) level manager or executive 12 with a detailed view of the inventory, and in particular the aging of the inventory, of each real estate office in the enterprise. The view, as depicted in FIG. 6, may include an Office Grid tabular display of offices, including the numerical rank of the office and the office manager. The Office Grid selects the office for which data is graphically displayed, as described above with reference to FIGS. 2A and 2B.

For each office selected in the Office Grid, the enterprise level Office Analysis Inventory view displays an Inventory Aging graphic display. The display may comprise a scatter plot graph of Active, Contingent, and/or Pending listings, wherein the units of the abscissa are DOM, and the units of the ordinate are property price. In one embodiment, the range and portion of the data displayed in the graph may be adjusted by a double-ended slider bar for the abscissa axis, and a sliding button for the ordinate axis. The double-ended slider bar operates as previously described. The sliding button has the effect of zooming the displayed graph to include a range of prices proportionate to the relative position of the slider button along its slider track. The display of Active, Contingent, and/or Pending listings may be selected by check buttons, and each type is preferably depicted in the graph with a separate data symbol. The Inventory Aging graph may include the feature that ranges of aging are indicated. Preferably, the ranges are indicated by vertical bars delineating the range (with reference to the abscissa). The vertical bars may be color-coded. For example, a green bar at 60 days may delineate the 0-60 day range, a yellow bar at 90 days may delineate the 61-90 day range, and a red bar at 180 days may delineate the range from 90-180 days.

The Office Analysis Inventory view may additionally display a second tabular display, referred to an Inventory Grid, displaying each listing and information associated with it. The Inventory Grid may display, for example, one or more of the agent name, status of the listing, a code depicting the property type, the property address, DOM, DUC, the current listing price, the number of price reductions the property has experienced, and a co-listing agent, if any. This tabular display of property information is linked to the Inventory Aging graph. In particular, positioning a cursor over the graphic data point representing any property highlights the corresponding row in the tabular display. In one embodiment, indicating the property may also activate a mouse-over pop-up containing summary information related to the property, such as the agent name, property address, DOM, price, and number of price reductions. Note that for contingent and pending properties, the mouse-over popup may display DUC in lieu of DOM. The inventory view may additionally include a totals line, listing the total number and dollar volume of active listings, the number and dollar volume of listings that have accepted offers, the average DOM and average DUC.

Both the Inventory Aging graph and the Listing Grid change when a new office is selected in the Office Grid. This information view allows an enterprise manager 12 to view detailed information regarding the inventory and inventory aging of any office.

### Inventory View—Office Level

In one embodiment, the office level may present an Inventory view of information showing an individual real estate office's listings and the aging of those listings. The office level Inventory view is significantly similar to the enterprise level Office Analysis Inventory view of FIG. 6 for the corresponding office, without the Office Grid.

### Production View

A consistent set of Production views of information related to transactions of properties listed by the business may be provided in one or more embodiments. The Production view may be selected within an application or level of aggregation, such as by selecting a tab.

### Production View—Enterprise Level

In one embodiment, the enterprise level presents a Production view of aggregated information for listings and list and sell side transactions for all properties handled by the enterprise, extracted from the MLS database. The enterprise level Production view is substantially similar to the view depicted in FIG. 2B, but with numbers reflecting the entire enterprise.

The view may comprise both a tabular and graph display, which are linked together. The tabular display may list aggregate monthly activity, such as properties currently listed, and the list side, sell side and total of transactions. The table may also display all listed properties for the month, including those whose listings were removed, as well as the sold median price. These data may be displayed by number, dollar volume, or preferably both. The display may cover the previous twelve months or twenty-four months, selected by radio buttons.

The production view may additionally include a graphical display, preferably implemented as a stacked bar graph depicting list and sell side transactions by volume. The tabular and graph displays are linked, in that a mouse-over on a bar in the bar graph highlights the corresponding row in the tabular display. The graph may additionally optionally display a trend line, and/or a listed volume line.

### Production View—Enterprise Level, Office View

In one embodiment, an enterprise level Office Production view provides the enterprise (or regional) level manager or executive 12 with a view of the production activity of all real estate offices in the enterprise. The enterprise level Office Production view is similar to the enterprise level Inventory view of FIG. 5.

The view may include an Office Grid tabular display of offices, one per row, including one or more of the numerical rank of the office, the office manager 18, 22, 26, the number of listed properties during a selected time period by number and dollar volume, the total number of transactions (list+sell), by number and dollar volume. The duration of the office level production view data may be selected, such as YTD, QTD or MTD, by a drop-down selection list. In one embodiment, the table may be sorted according to any column.

The enterprise level Office Production view may additionally include a graphical display, such as a bar graph. When the Office Grid is sorted by the number or dollar volume of transactions, the graph may be a stacked-bar graph showing list and sell side transactions for each office. When the Office Grid is sorted by the number or dollar volume of listed properties, the graph may be a bar graph showing the relative number of listed properties for each office. In either case, in one embodiment the bar graph is linked to the tabular display with mouse-over/row highlighting as described above. The number and selection of offices displayed in the bar graph may be controlled by a double-ended slider bar as described above. The bar graph may include a median line. Both the table and graph may support drill down and export capability.

The enterprise level Production view aggregates data across the entire enterprise, and displays it in a manner that facilitates monitoring the enterprise's productivity. The enterprise level Office Production view also displays data across the entire enterprise; however, it is segregated by real estate office, to facilitate the management of plural offices by comparing their productivity.

### Production—Enterprise Level, Office Analysis View

The enterprise level, Office Analysis Production view provides the enterprise (or regional) level manager or executive 12 with a detailed view of the production activity of each individual real estate office in the enterprise, and is depicted in FIG. 2A. A particular real estate office may be selected via the Office Grid 46.

For a given office selected, the displayed view 48 is substantially similar to the display 50 (FIG. 2B) of the office level Production view (discussed below), which is directly analogous to the enterprise level Production view (discussed above). The view includes a tabular display listing monthly totals of activity, including one or more of the number of listed properties by number and dollar volume, the total number of transactions (list+sell), by number and dollar volume, and the median price of the properties. In one embodiment, the table may be sorted according to any column.

The Production view may additionally include a graphical display, which is preferably a stacked bar graph showing list and sell side transactions for each office. When the Office Grid is sorted by the number or dollar volume of listed properties, the graph is preferably a bar graph showing the relative number of listed properties for each office. In either case, the bar graph is linked to the tabular display with mouse-over/row highlighting as described above. The number and selection of agents displayed in the bar graph is controlled by a double-ended slider bar as described above. The bar graph may include a median line. Both the table and graph support drill down and export capability.

### Production—Office Level

In one embodiment, the office level presents a Production view of information, extracted from the MLS database 16, related to the listed properties and transactions of a single office, as depicted in FIG. 2B. The office level Production view is substantially similar to the enterprise level Office Analysis Production view, with the omission of the Office Grid, and includes all of the features and capabilities described with respect to that view. Furthermore, the office level Production view is directly analogous to the enterprise level Production view, but only aggregating the data from a single real estate office rather than across the enterprise.

### Production—Office Level, Agent View

Directly analogous to the enterprise level Production view and enterprise level Office Production, in one embodiment the office level provides both an office level Production view (described above) and an office level Agent Production view. The office level Agent Production view is similar to the enterprise level Office Production view. It analyzes data across all agents 30, 34, 38 in a real estate office, and presents the data for all agents 30, 34, 38 on a per-agent basis. This facilitates management of the office by presenting the relative productivity metrics of each agent 30, 34, 38 for comparison to all other agents 30, 34, 38.

The view may include a tabular display, referred to as an Agent Grid (analogous to the Office Grid discussed above), displaying the agent name and numerical ranking, one agent per row. The Agent Grid may additionally display, by both number and dollar volume, each agent's listed properties and total (list+sell) transactions. The Agent Grid may be linked to a bar chart depicting, one bar per agent, the list and sell side transactions in a stacked bar format when the Agent Grid is sorted on a transactions column, and displaying listed properties in a single bar format when the Agent Grid is sorted on a listed column. The office level Agent Production view allows an office manager 18, 22, 26 to inspect and analyze detailed Production data related to each agent 30, 34, 38 Oust as the enterprise level Office Production view allows an enterprise level manager 12 to inspect and analyze detailed Production data related to each office).

### Production—Office Level, Agent Analysis View

Similar to the suite of views available to the enterprise level manager 12 for viewing detailed office level production data (in a format and user interface substantially similar to that of the office level view), so too the office level manager 18, 22, 26 has at his disposal a suite of Agent Analysis tools for accessing detailed production data for each agent 30, 34, 38.

In one embodiment, the display and user interface (that is, the “look and feel”) of office level Agent Analysis Production view is substantially similar to the enterprise level Office Analysis Production view, with agent level data substituted for office level data. In particular, the view may include an Agent Grid tabular display depicting, one agent per row, the agent rank (the initial sort field) and name. This allows the office manager 18, 22, 26 to select the desired agent 30, 34, 38. A view may include stacked bar (transactions) or bar (listed) graphs and linked tabular display, one month per bar/row, as described with respect to the enterprise level Office Analysis Production view.

The commonality of both the data and the display and user interface between the office and agent levels provides the same benefit at the office level as does the commonality between the enterprise and office levels at the regional or enterprise level, as discussed above.

### Transaction Coverage View

In one embodiment, an additional view is unique to the office level, and depicts the geographical distribution of the volume of a real estate office's list and sell activity. The Transaction Coverage view may comprise a stacked bar graph depicting list and sell side transactions (selectably active or sold listings), with an ordinate axis representing dollar or unit volume, and an abscissa axis identifying geographic regions. The geographic regions may be selectable, such as county, city, MLS area, zip code, and the like. A text display of the percentage of the office's total transactions represented by each bar may be displayed. Corresponding data may be displayed in tabular format. The Transaction Coverage view may be similar to the Production view of FIG. 2B. The Transaction Coverage view allows a real estate office manager 18, 22, 26 to quickly see which areas are generating the most activity for the office.

### Measure View

In one embodiment, a consistent set of Measure views of information related to transactions regarding properties listed by the real estate business, derived from the MLS database, is provided. The Measure views define and display unique and novel metrics useful in measuring several aspects of a real estate business's performance. The metrics are preferably calculated on a rolling 12-month average basis. Modest or incremental improvements to these metrics may have dramatic positive effect to the bottom line.

### Measure—Enterprise Level

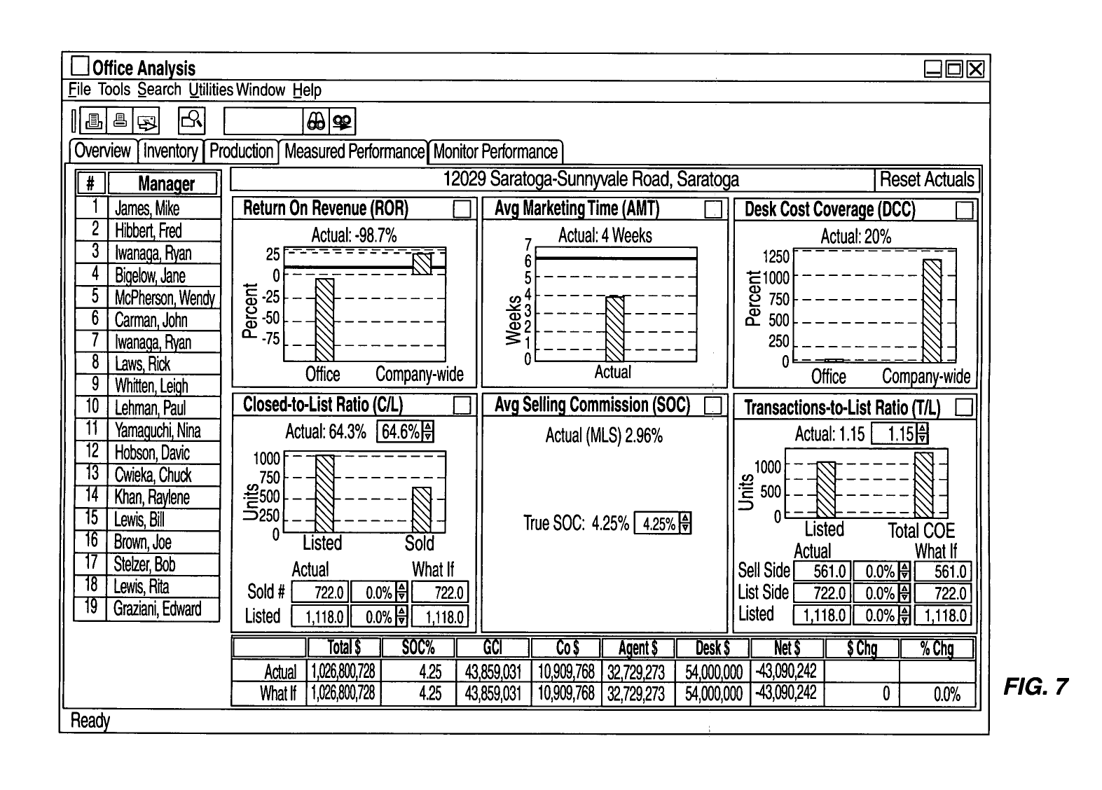

In one embodiment, the enterprise level provides a Measure view of aggregate listing and transaction activity across the enterprise. The Measure view displays a snapshot of particular, novel metrics that provide an overview of how efficiently the enterprise is operating and allows the user to project the effects of incremental changes in key financial and transaction areas. The metrics are calculated over all listings and transactions in the enterprise. The enterprise level Measure view is similar to the display depicted in FIG. 7, without the Office Grid, and with numbers reflecting the aggregation of all properties across the enterprise.

According to one embodiment, the Measure view calculates and displays a Closed to List Ratio (C/L), defined as the number of properties sold during a specified time period divided by the number listed, and expressed as a percentage. The numbers of listed and sold properties may be displayed in a bar graph, with the C/L ratio displayed as a percentage. In one embodiment, the C/L ratio may be altered, either by entering a different number, or by incrementing or decrementing the displayed value via spinners (small icons that increment/decrement the value in response to mouse-clicks). The numeric values of the listings and sold properties may also be displayed, along with “what if” displays of altered values. The altered values are generated based on user-changeable percentage increase/decrease fields associated with each value. A user may thus experiment with the effect of changes in either, or both, values.

Another parameter calculated and displayed in the Measure view is the Average Marketing Time (AMT), which is displayed both numerically and as a bar graph. The graph may include separate bars for Active, Expired, Sold, C/P and A/C/P/X/S listings. The average actual marketing time may also be displayed numerically.

The Measure view may additionally display the actual average Selling Office Commission (SOC) as a numeric percentage, and a variable value that may be altered by direct input, or by incrementing or decrementing via spinner icons.

Another novel Measure metric that may be calculated and displayed is the transaction to list ratio (T/L), which may be displayed numerically and as a bar graph comprising a solid bar for listed properties and a stacked-bar displaying list side and sell side transactions. The actual T/L value may be displayed, along with a variable value that the user may alter by direct entry or via spinner icons. In addition, the actual and variable values of the constituents of the T/L—the list and sell side transactions and listed properties—may be displayed, with a variable percentage scaling factor to allow for altering each variable independently for “what if” calculations.

The bottom line effect of the “what if” changes may be reflected in an actual and “what if” tabular display, depicting for each the total dollar volume of transactions, GCI, Company dollars, Desk dollars, Net dollars, and the change from actual, both in dollars and as a percentage.

The Measure view may additionally calculate display a Return on Revenue (ROR) metric. This is the amount of agent GCI retained by the broker.

Another Measure metric that may be calculated and displayed is the Desk Cost Coverage (DCC). DCC is a measure of total annual expenses divided by twelve, divided by the number of “desks,” or agents and associates. The DCC is calculated over four seasons to remove seasonal market dependencies.

As an example of the power of these measuring metrics, consider a national enterprise wherein software according to one or more embodiments describe herein is fully deployed and utilized, with total dollar volume listings of $12.17B and CGI of $348.5M. If each office within the enterprise could net one more listing a month and net one more sell side transaction per month, the company commission margin would increase slightly (0.02%) and the C/L ratio would increase by two points. The net to the bottom line, however, would be an approximate 12% increase amounting to $6.85M. This increase is almost pure profit, as all expenses of running the enterprise have already been accounted for. The details of this representative analysis are included in the BrokerMetrics™ Enterprise Description, incorporated herein by reference.

### Measure—Enterprise Level, Office Analysis View

The enterprise level Measure view aggregates data for all listings and transactions across the enterprise. To allow enterprise level managers 12 to analyze Measure metrics for individual offices, an enterprise level Office Analysis Measure view may be provided, as depicted in FIG. 7.

As with other enterprise level Office Analysis views, the Measure view includes an Office Grid, depicting, one office per row, the numeric ranking and office manager name for each office in the enterprise (or region). When a particular office is selected, the remainder of the view depicts Measure view information for listings and transactions of only that office.

The enterprise level Office Analysis Measure view is substantially similar in display and user interface to the enterprise level Measure view described above (with only data from a single office aggregated and analyzed). That is, the view may include bar graph and numeric displays of ROR, DCC, C/L, AMT and T/L, with “what if” analysis capability for the C/L and T/L displays. The view may also include the actual and variable SOC % display, and the Actual and What If bottom line displays, as previously described. One difference is that, for one or more of the metrics displayed, such as ROR and DCC, the respective graphs may display both the office's metric and that for the enterprise as a whole. This may help assess an individual office's performance with that of the organization.

As an example of the effect the Measure view metrics on real estate office metrics, consider a real estate office with total listings of $600.5M and GCI of $17.7M. Raising the C/L 4 percentage points (61 to 65%), adding one listing every month (699 to 711) and securing one additional buyer every month (358 to 370) results in average commissions increasing slightly (0.02%, from 2.95 to 2.97), but with a bottom line increase of 8.7%, or $275,000. The increase is dramatic because no additional expenses were incurred; they result from improved efficiency. The details of this representative analysis are included in the BrokerMetrics™ Enterprise Description, incorporated herein by reference.

### Measure—Office Level

In one embodiment, an office level Measure view is virtually identical to the enterprise level Office Analysis Measure view of FIG. 7, with the omission of the Office Grid tabular display, and with the relevant data limited to a particular office. The view includes bar graph and numeric displays of ROR and DCC (including both office and company-wide metrics), C/L, AMT and T/L, with “what if” analysis capability for the C/L and T/L displays. The view includes the actual and variable SOC % display and the Actual and What If bottom line displays, as previously described.

### Measure—Office Level, Agent Performance View

Among the Agent Performance suite of views available to the office manager 18, 22, 26 to analyze detailed agent level data may be a Measure view. The office level Agent Performance Measure view is substantially similar to the enterprise level Office Analysis Measure view of FIG. 7, with an Agent Grid substituted for the Office Grid. Selecting an agent on the Agent Grid alters the selection of data displayed in the rest of the view.

The office level Agent Performance Measure view differs from the enterprise level Office Analysis Measure view and the office level Measure view primarily in the addition of a Commission Splits display. Four values are displayed: actual and “what if” Agent % and Company %. Additionally, the Actual and What If bottom line tabular display includes Agent dollars.

### Enter Goals

As the business's performance is measured and management develops specific, quantified goals, these goals are entered into the applications. These may be entered, for example via an Options menu selection, with numeric input fields for either minimum values, maximum values, or both minimum and maximum values (to define a range) for each of the metrics measured, such as C/L, T/L, AMT, ROR, SOC, DCC and the like. Goals may also be set for actual production parameters, such as a percentage variance from the previous year's actual values. Access to the goals-setting functionality may be strictly limited, such as through additional password protection. Goals may be entered at the enterprise (or regional) and office levels.

### Monitor View

Once real estate agents 30, 34, 38 and managers 12, 18, 22, 26 understand the importance and potential impact on their business of improvements in the various metrics displayed in the Measure views, and have entered goals for actual performance, the software according to one embodiment provides a quick, visual method of monitoring the business's performance with respect to these metrics over time. In particular, the performance relative to predetermined goals is displayed in an intuitive visual manner.

### Monitor—Enterprise Level

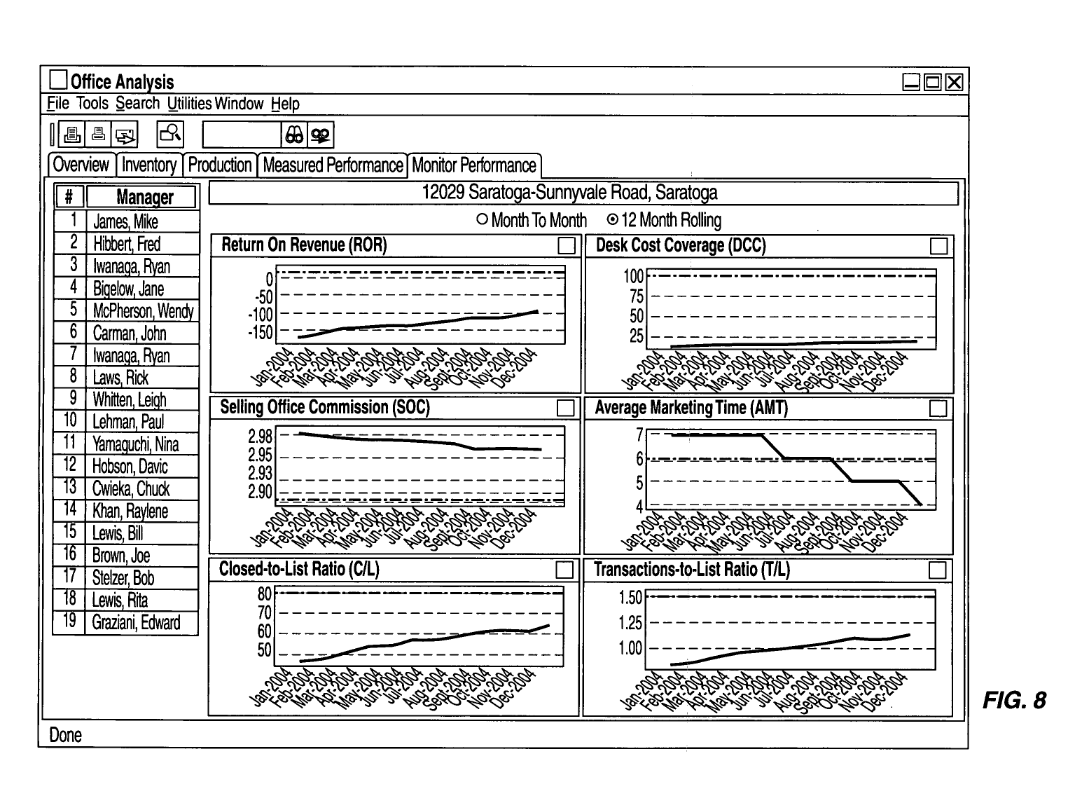

In one embodiment, the enterprise level provides a Monitor view, allowing an enterprise manager 12 to quickly check the performance of the entire enterprise against established goals. An enterprise level Monitor view is similar to that depicted in FIG. 8, without the Office Grid, and with the parameters calculated across the entire enterprise. A variety of metrics or parameters may be displayed in line graphs, with either a discrete level or a band, or range, indicating goals overlaid or superimposed in a distinctive color. Two views may be available for the metrics and parameters: a month-to-month view that displays totals for the previous twelve full months, and a twelve month rolling view that displays annual totals for each of the previous twelve months. As an example of the latter, the data point for May 3 would show the total for the period from May 1, 2002 through Apr. 30, 2003. The parameters displayed may include some or all of the C/L, SOC, T/L, AMT, ROR and DCC, or other relevant parameters as necessary or desired.

### Monitor—Enterprise Level, Office Analysis View

In on embodiment the enterprise level Office Analysis Monitor view allows the enterprise manager 12 to monitor the performance metrics on a per-office basis. The view, depicted in FIG. 8, comprises the graphs described above, with an Office Grid for selection on of a plurality of offices for which to display the metrics graphs. When an office is selected in the Office Grid, the enterprise level Office Analysis Monitor view aggregates MLS data for listings and transactions by that office, calculates the present and historical metrics values, and presents the graphs as described above.

### Monitor—Office Level

In one embodiment, the office level Monitor view is directly analogous to the enterprise level Monitor view, with the graphs reflecting data relating only to the office.

### Monitor—Office Level, Agent Performance View

Included in the Agent Performance suite of views available at the office level, to monitor the performance of individual agents, may be a Monitor view. The office level Agent Performance Monitor view is directly analogous to the enterprise level Office Analysis Monitor view, with the substitution of an Agent Grid for the Office Grid. Selecting an agent plots the Measure metrics for that agent's listings in graphical displays as described above.

### Defining Custom Markets

In generating the views described above, the data extracted from the MLS database 16 comprises only that data related to properties handled by the real estate business (e.g., only data relating to one or more agents, real estate offices, or the entire enterprise). However, the sophisticated data mining capabilities of the present invention may additionally be applied to analyze competitors' performance, and/or to track specific aspects of specific segments of the real estate market.

According to one embodiment, a user may define their market in terms of competitors, and data mine the MLS data related to those competitors to present a real-time analysis of the market, according to a variety of metrics and parameters. The market may only need to be defined once, after which even non-technical users may view competitive data, such as relative new activity, market share, and the like. The Market view concept may be applied consistently across all levels of aggregation. Additionally, users of upper levels of aggregation may create and monitor Market views for lower level units as well as for their own aggregate information. In one embodiment, the displays and user interfaces are analogous, as explained above with respect to enterprise level Office Analysis views vs. office level views, and office level Agent Performance views vs. agent level views. Hence, the Market view is described in detail herein with respect to the office level of aggregation.

In one embodiment, the office level includes a Market view that allows a user to define his or her market one time, and then view the performance and market activity of his or her own office relative to competitors on an ongoing basis. Upon initially invoking the Market view, a user is guided through the process of defining a market, such as via the use of a wizard, as well known in the software arts. The user defines a market by selecting one or more competing real estate offices, and optionally grouping the competing offices into one or more groups. The groups may be further aggregated into competitor sets. The market definition wizard may display a list of offices from which the user may select. The list may be constrained by the number of agents in the office or the total dollar volume of the office's listings.

### Market Share

In one embodiment, once the competing offices or groups have been selected, a Market Share analysis tool provides real-time market share information in two useful ways: current totals from either a dollar volume or units perspective over any desired date range; and market penetration over time (trending). The latter answers the question, “Who is gaining, who is staying the same, and who is losing market share over time?” The Market Share analysis may be available at all levels of aggregation: enterprise, office and agent. At each level, the Market Share data may be viewed as current totals or as trends.

### Market Share—Totals

In one embodiment, a Market Share (Totals) analysis begins with a search of MLS data against very specific user-defined criteria. These criteria may include one or more of market share type; listing type; property type; area; date range; price range; and desired bedroom-bathroom configuration. The market share type allows the user to compare offices to other offices, brokers to other brokers, or create his or her own comparison sets by using a Custom Market Share Wizard. The default market share type is office. Listing record type is sold or active, selected by radio button. The default is sold properties.

Property type may be, for example, residential, lots and land, or other. In one embodiment, Property type is a required field, and there is no default value. Property type selection at the enterprise level will likely be limited, as it represents an aggregation of data from multiple, regional MLS databases 16, which do not maintain a consistent classification of property types. Hence, specific, detailed property type codes from different MLS's may be grouped into necessarily more generic property type descriptions, that are available at the enterprise level search criteria. Conversely, at the office and agent levels, the property type selection list is likely more extensive, as it includes the specific property types into which the local or regional MLS classifies properties. Note that while in general the office or agent level property type search is more detailed than the enterprise level, the selection choices will vary among different “localizations” of software according to various embodiments, due to different MLS databases 16. However, the property types will match those the office manager is used to, as they reflect the local MLS classifications. A representative list of office or agent level property type search criteria may include residential, multi-unit, commercial, lots and land, mobile homes, commercial office, commercial industrial, agricultural and the like.

Area type may include cities, counties, or all MLS. Cities and counties bring up a list from which the user may select one or more entries. With the capability to run market share calculations against any individual MLS within their market area or against them all at once, management can use their market knowledge to create custom market share groups to aggregate offices and/or companies when MLS information is inconsistent or incomplete.

The number of bedrooms and full bathrooms may optionally be selected, by check boxes. The date range may be selected from a drop down list, including for example YTD, QTD, MTD, last 6 months, last 12 months, and Custom, which may bring up a calendar tool for entering a specific date range. Price range is blank by default. Upper and lower limits are entered by the user, and are limited to increments of one thousand.

Once the search is run against user-supplied criteria, a Market Share—Totals view is displayed. The Market Share—Totals view may comprise a bar graph depicting total listings (active or sold, as selected in the search criteria), with each bar aggregating the market share type selected (e.g., offices, brokers or competitor set). The ordinate may be selected between, e.g., dollar or unit volume. The Market Share—Totals view may, for example, be similar to that depicted in FIG. 2B. The percentage of the defined market represented by each bar may optionally be displayed. In one embodiment, the display may be toggled between graphic display and tabular display, such as by selecting a mouse button. All offices or brokers meeting the search criteria may be listed in the tabular display, which supports diving down to retrieve information related to either the office/broker or listing. In one embodiment, the user may select specific offices/brokers in the tabular display, and only these will be displayed upon toggling to the graphic display. Only the selected entries may be displayed in the tabular display by selecting a mouse button. To restore the views to include all results, the user may select a clear selections mouse button.

### Market Share—Trends

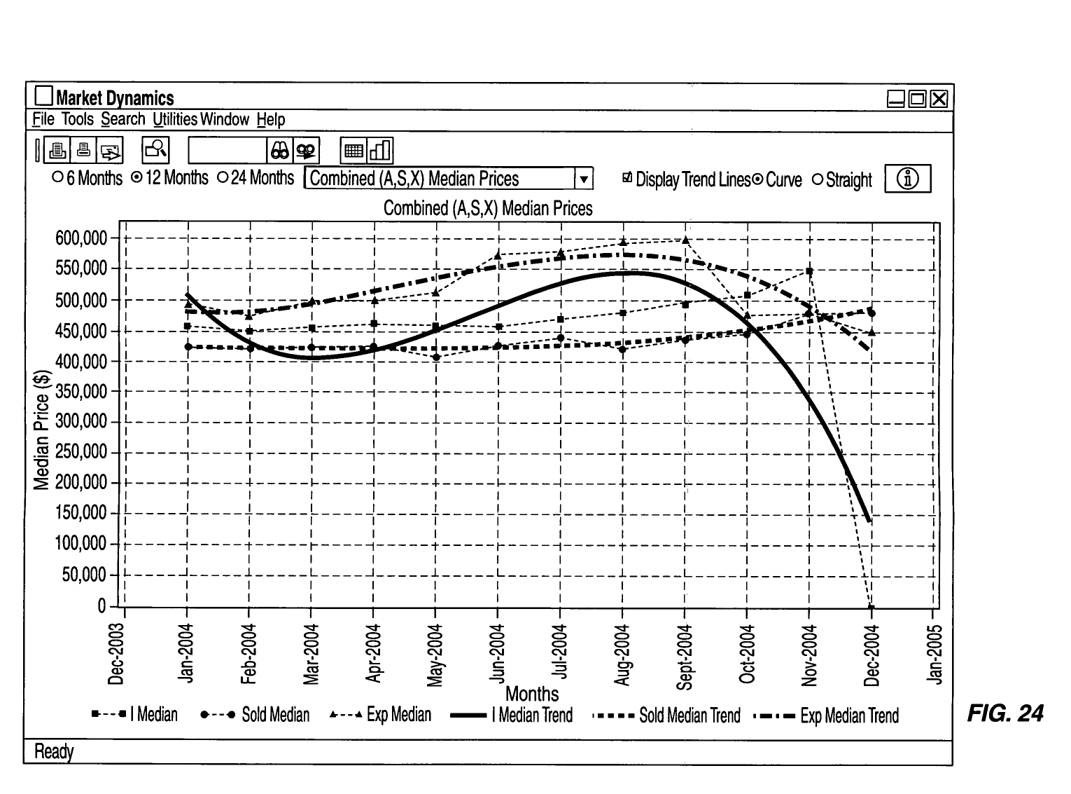

In one embodiment, upon invoking the Market Share—Trends analysis, the user again supplies criteria for a search of MLS data, as described above. In one embodiment, upon completing the search, a line graph plotting the month-to-month market share for the selected offices, brokers or competitor set is displayed. For example, the display may be similar to one of the line graphs depicted in FIG. 24, with the ordinate selectable between, e.g., dollar volume, percent market share by dollar, unit volume or percent market share by unit. The abscissa displays demarcations of a predetermined time period, such as the previous twelve months. The line graph may be toggled between a month-to-month view and a rolling 12-months view, such as by radio buttons. The rolling average basis allows the user to see who is gaining or losing market share over time. The display may also be toggled to a tabular display, as described above.

### Market Dynamics

In one embodiment, a Market Dynamics analysis tool provides a large plurality (e.g., sixteen) of different views of various market parameter and ratios, calculated from real time MLS data. The user may select 6, 12, or 24 month time periods, display trend line overlays, and optionally access extensive explanatory information to help interpret the graphs, to gain insight and understanding of the user's relevant real estate market.

The Market Dynamics analysis tools are preferably consistent across all levels of aggregation, including the enterprise level, the office level, and the agent level (with the exception noted above regarding the property type selection lists in conducting a search of MLS data). At the enterprise and office levels, the Market Dynamics analysis tools provide strategic information on real estate market activities that allow the business to plan and adjust business activities. A rich supply of views of market dynamics may be provided in support of this function. At the agent level, the Market Dynamics analysis tool may primarily function as a sales tool for the agent. By competently and accurately discussing and demonstrating to potential clients the agent's mastery of the real estate business and knowledge of the market, the agent gains credibility and trust, and is viewed as an expert, all of which help attract clients and increase listings. Hence, the agent level Market Dynamics analysis tool may provide only the broader, more generally recognized and understood views of market dynamics.

The Market Dynamics analysis begins with a search against user-defined criteria, as described above with respect to the Market Share analysis. Once the search is complete, a variety of different views of the data is available, and may be selected, such as from a drop-down list. For each view, the time period displayed may be selectable between 6, 12 or 24 months, selected via radio buttons. In one embodiment, by clicking a check-box the user may optionally display a trend line, which is displayed as a curve or straight line, selectable via radio buttons. For each view, the user may also toggle the display between graphic and tabular formats, such as by selecting mouse buttons with corresponding icons.

### Sold Listings—Median Price

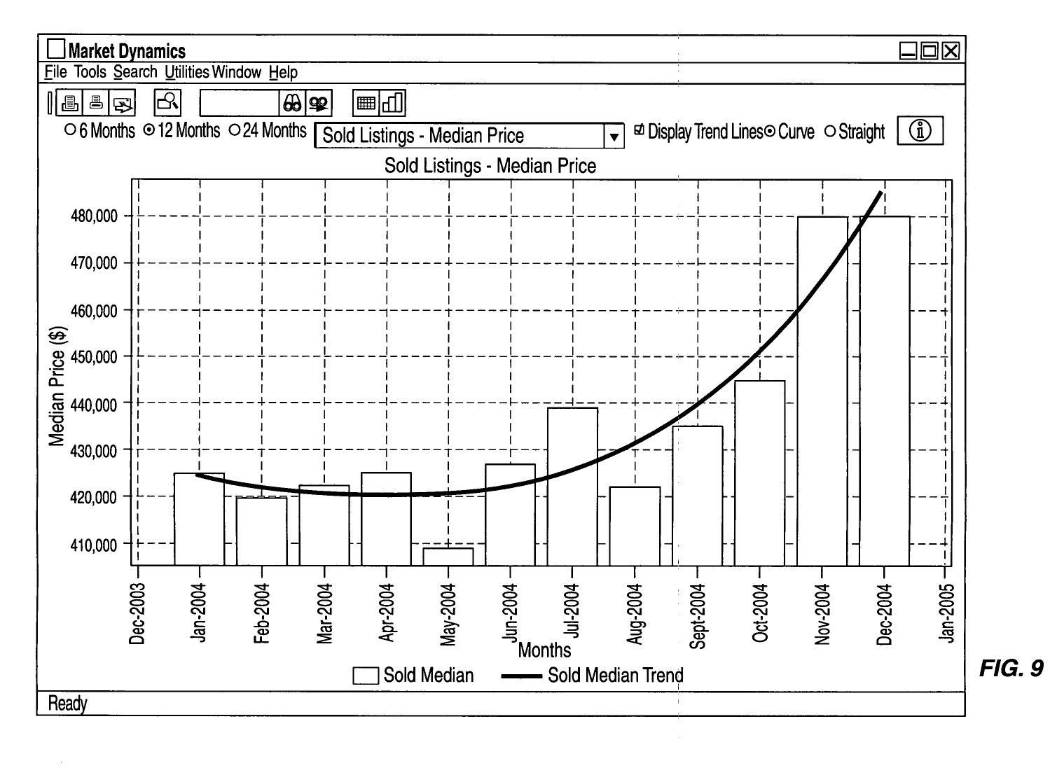

This view, depicted in FIG. 9, displays the median price of closed escrows (sold listings) measured on a monthly basis. For any given set of property criteria, this chart depicts the change in the median price of the properties closing escrow (sold listings) on a month-by-month basis. The resultant information may be viewed from either a 6-month, 12-month (default), or Year-over-Year perspective. This is an indirect measure of market demand, i.e. rising prices for sold properties generally indicate increased demand and stronger market conditions. Some generalized market conditions can be inferred from the directional movement of the underlying trend lines:

Upward—market strength is increasing. The trend line moving upwards, over time, indicates a market that is gaining in strength due to increased demand putting upward pressure on prices.

Parallel—market is in equilibrium. A parallel running trend line indicates steady, balanced market conditions with prices remaining stable.

Downward—market strength is decreasing. The trend line moving downwards, over time, indicates a market that is decreasing in strength due to decreased demand putting downward pressure on prices.

### Active Listings vs. Sold Listings—Units

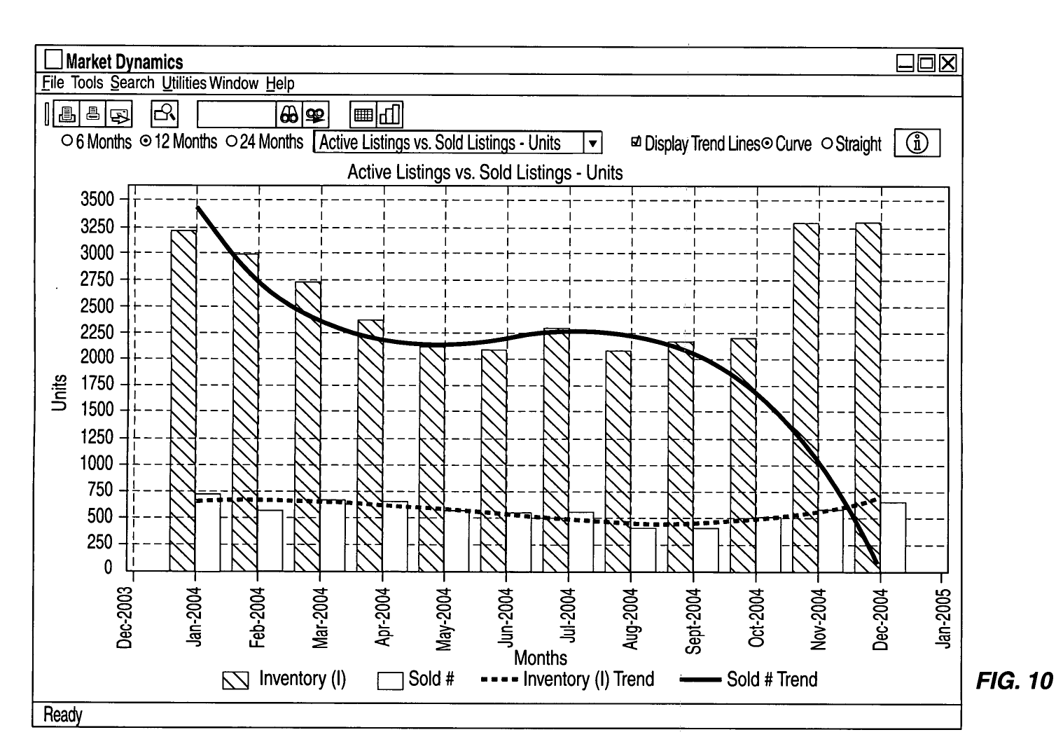

This view, depicted in FIG. 10, displays the number of active listings (properties for sale) compared with the number of sold listings (closed escrows) on a monthly basis. For any given set of property criteria this chart compares the number of properties that are currently for sale with the number that are exiting the market due to closed escrows on a month-by-month basis. The resultant information can be viewed from either a 6-month, 12-month (default); or Year-over-Year perspective. The size (# of Active properties) and strength (# of Sold properties) of the market segment are depicted visually and thus easy to comprehend. Some generalized market conditions can be inferred from the directional movement of the underlying trend lines:

Converging—market strength increasing. Trend lines converging indicate that supply (active listings) is decreasing while demand (sold listings) is increasing. These conditions, over time, tend to favor sellers.

Parallel—market in equilibrium. Trend lines moving in an approximately parallel manner indicate that supply (active listings) and demand (sold listings) are in equilibrium. This is indicative of balanced conditions between buyers and sellers.

Diverging—market strength decreasing. Trend lines diverging indicate that supply (active listings) is increasing while demand (sold listings) is decreasing. These conditions, over time, tend to favor buyers.

### Active Listings vs. Accepted Offers—Units

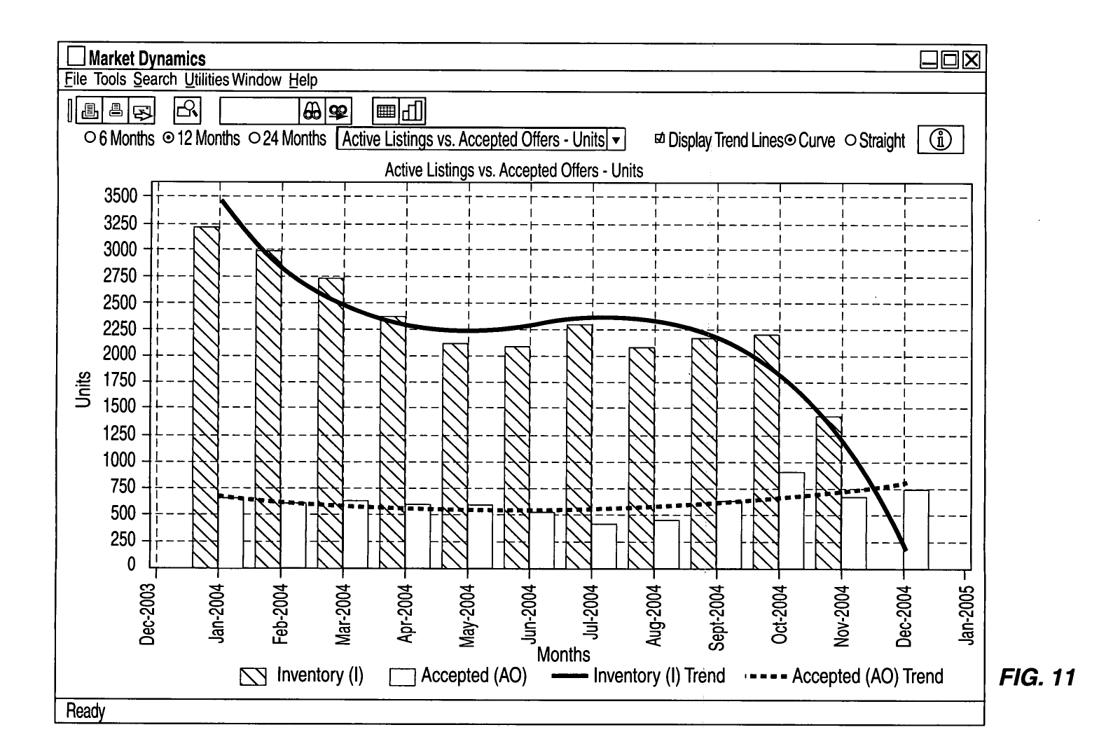

This view, depicted in FIG. 11, displays the number of active listings (properties for sale) compared with the number of listings that receive accepted offers on a monthly basis. For any given set of property criteria this chart compares the number of properties that are currently for sale with the number that receive accepted offers on a month-by-month basis. The resultant information can be viewed from either a 6-month, 12-month (default), or Year-over-Year perspective. The size (# of Active properties) and current activity (# of Accepted-Offers) of the market segment are depicted visually and thus easy to comprehend.

This is one of the most “contemporaneous” views of underlying market conditions because it directly measures the proportion of ready, willing, and able buyers (current demand) within any market segment on a month-by-month basis. Some generalized market conditions can be inferred from the directional movement of the underlying trend lines:

Converging—market strength increasing. Trend lines converging indicate that supply (active listings) is decreasing while demand (sold listings) is increasing. These conditions, over time, tend to favor sellers.

Parallel—market in equilibrium. Trend lines moving in an approximately parallel manner indicate that supply (active listings) and demand (sold listings) are in equilibrium. This is indicative of balanced conditions between buyers and sellers.

Diverging—market strength decreasing. Trend lines diverging indicate that supply (active listings) is increasing while demand (sold listings) is decreasing. These conditions, over time, tend to favor buyers.

### Month's Supply of Inventory (MSI) vs. Median DOM

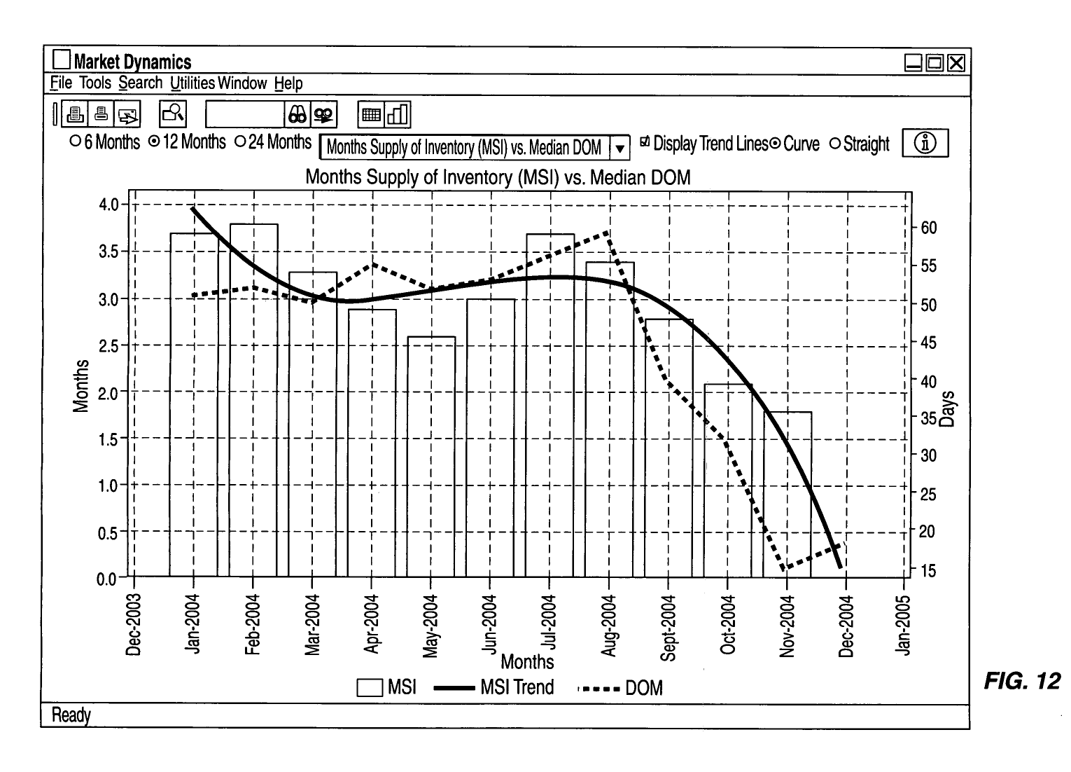

This view, depicted in FIG. 12, displays the number of months of inventory currently in the market relative to existing sales rates. For any given set of property criteria this chart depicts the number of remaining months of inventory on a month-by-month basis. The resultant information can be viewed from either a 6-month, 12-month (default) or Year-over-Year perspective. This figure reflects current market conditions because it is measuring buyer demand on a monthly basis. Some generalized market conditions can be inferred from the directional movement of the underlying trend line:

Upward—market strength is decreasing. The trend line moving upwards, over time, indicates a market that is decreasing in strength due to decreased buyer demand.

Parallel—market is in equilibrium. A parallel running trend line indicates steady, balanced market conditions.

Downward—market strength is increasing. The trend line moving downwards, over time, indicates a market that is increasing in strength due to increased buyer demand.

### Percentage: Accepted Offers to New Listings

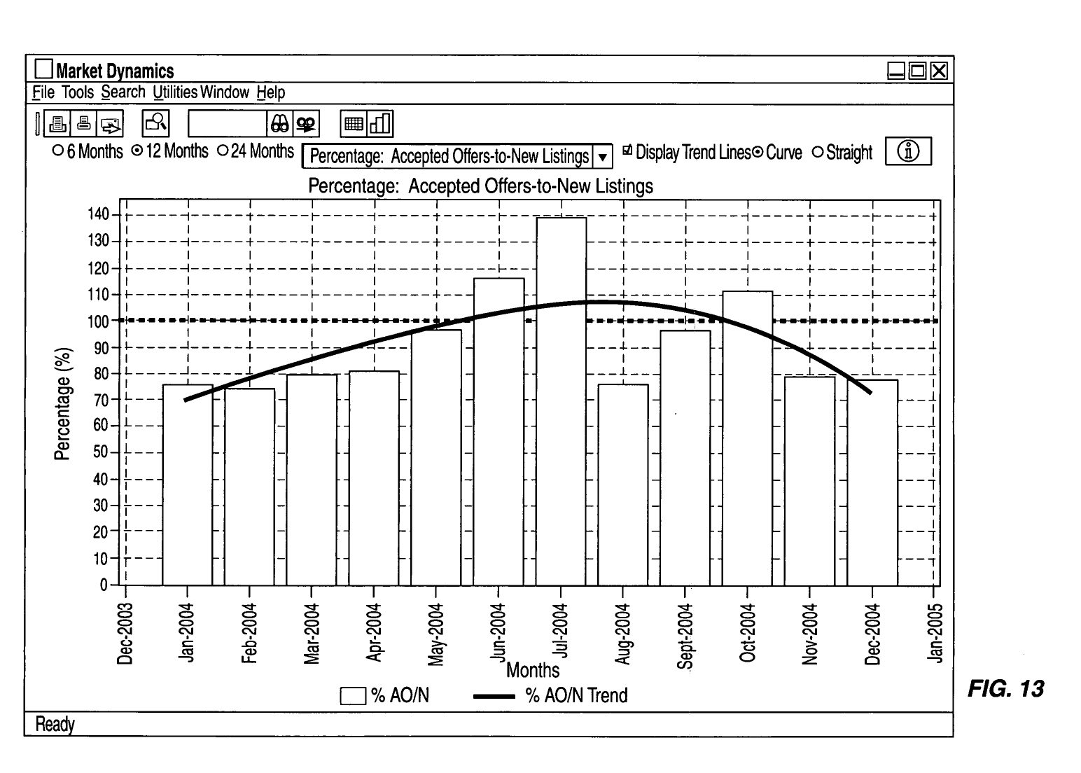

This view, depicted in FIG. 13, displays the percentage of new listings that receive accepted offers on a monthly basis. For any given set of property criteria, this chart depicts the percentage of new listings that receive accepted offers on a month-by-month basis. The resultant information can be viewed from either a 6-month, 12-month (default), or Year-over-Year perspective. This ratio is a direct measure of market conditions because it is measuring buyer demand on a monthly basis. Some generalized market conditions can be inferred from the directional movement of the underlying trend line:

Upward—market strength is increasing. The trend line moving upwards, over time, indicates a market that is increasing in strength due to increased buyer demand.

Parallel—market is in equilibrium. A parallel running trend line indicates steady, balanced market conditions.

Downward—market strength is decreasing. The trend line moving downwards, over time, indicates a market that is decreasing in strength due to decreased buyer demand.

### Median Sold Price vs. DOM

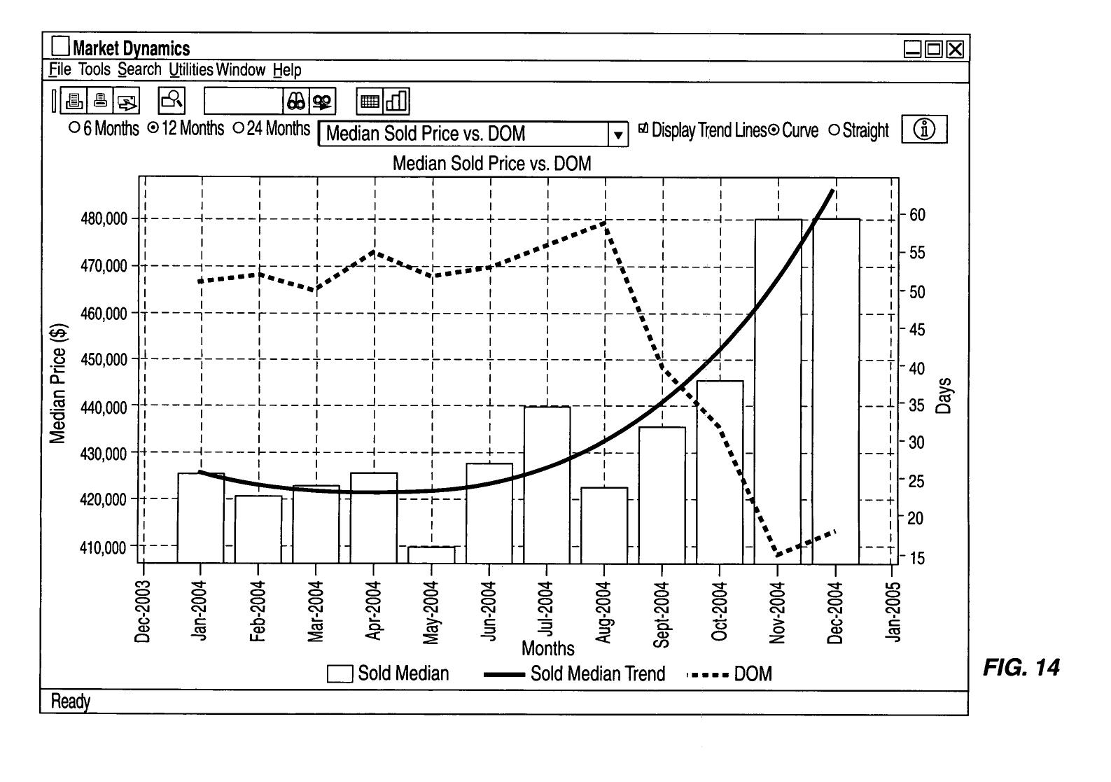

This view, depicted in FIG. 14, displays the median price of sold listings compared with the median DOM (Days-On-Market). For any given set of property criteria, this chart compares the change in the median price of the properties closing escrow (sold listings) with the median marketing time on a month-by-month basis. The resultant information can be viewed from either a 6-month, 12-month (default) or Year-over-Year perspective. This is an indirect measure of market demand, i.e. rising prices combined with lower marketing times generally indicate increased demand. Some generalized market conditions can be inferred from the directional movement of the underlying trend lines:

Upward Price & downward DOM—market strength increasing. Upward pricing pressure and shorter marketing time frames result from increasing demand.

Parallel—market is in equilibrium. Parallel running trend lines indicate steady, balanced market conditions with prices and marketing time frames remaining stable.

Downward Price & upward DOM—market strength decreasing. Downward pricing pressure and longer marketing time frames result from decreasing demand.

### New Listings vs. Accepted Offers—Units

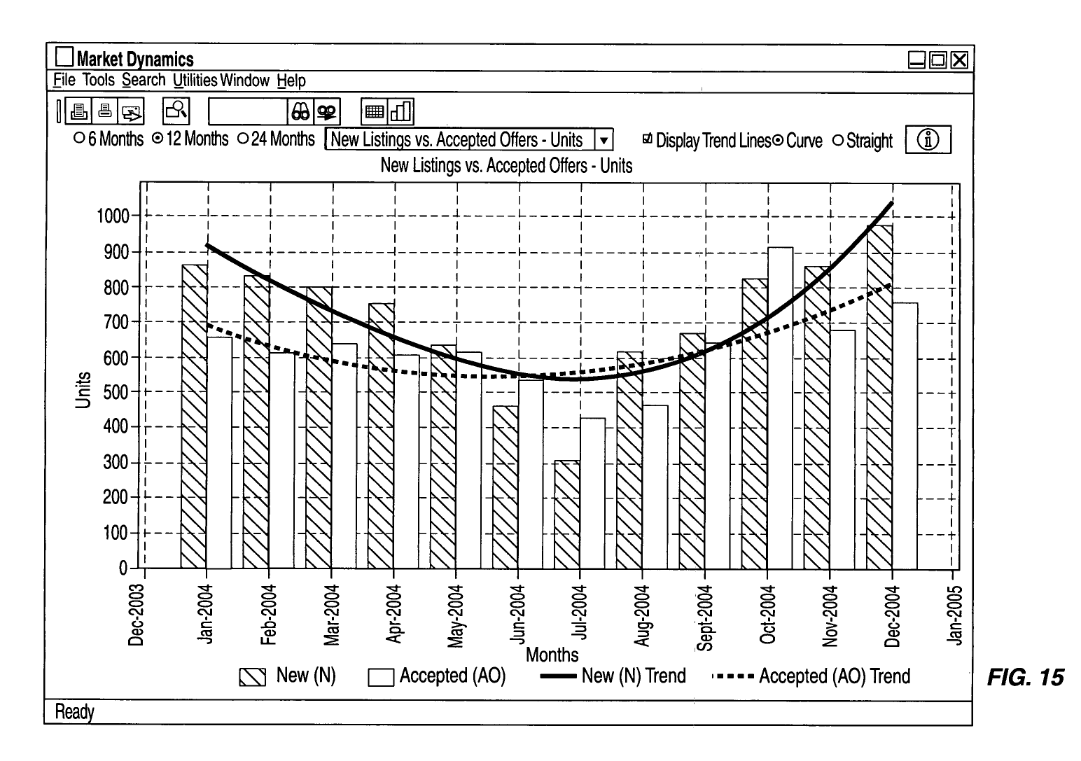

This view, depicted in FIG. 15, displays the number of new listings entering the market compared with the number of accepted offers (listings exiting the market) on a monthly basis. For any given set of property criteria this chart compares the number of properties that are entering the market to add to the existing inventory with the number that are exiting the market due to receiving accepted offers on a month-by-month basis. The resultant information can be viewed from either a 6-month, 12-month (default) or Year-over-Year perspective. The incremental addition (# of new listings) to the market is compared with the incremental subtraction (# of accepted offers). The results are depicted visually and thus easy to comprehend.

This is one of the most “contemporaneous” views of underlying market conditions because it directly measures supply (new listings) against demand (the proportion of ready, willing, and able buyers) within any market segment on a month-by-month basis. Some generalized market conditions can be inferred from the directional movement of the underlying trend lines:

Converging—market strength increasing. Trend lines converging indicate that supply (active listings) is decreasing while demand (sold listings) is increasing. These conditions, over time, tend to favor sellers.

Parallel—market in equilibrium. Trend lines moving in an approximately parallel manner indicate that supply (active listings) and demand (sold listings) are in equilibrium. This is indicative of balanced market conditions.

Diverging—market strength decreasing. Trend lines diverging indicate that supply (new listings) is increasing while demand (accepted offers) is decreasing. These conditions, over time, tend to favor buyers.

### Active Listings vs. Expired Listings—Units

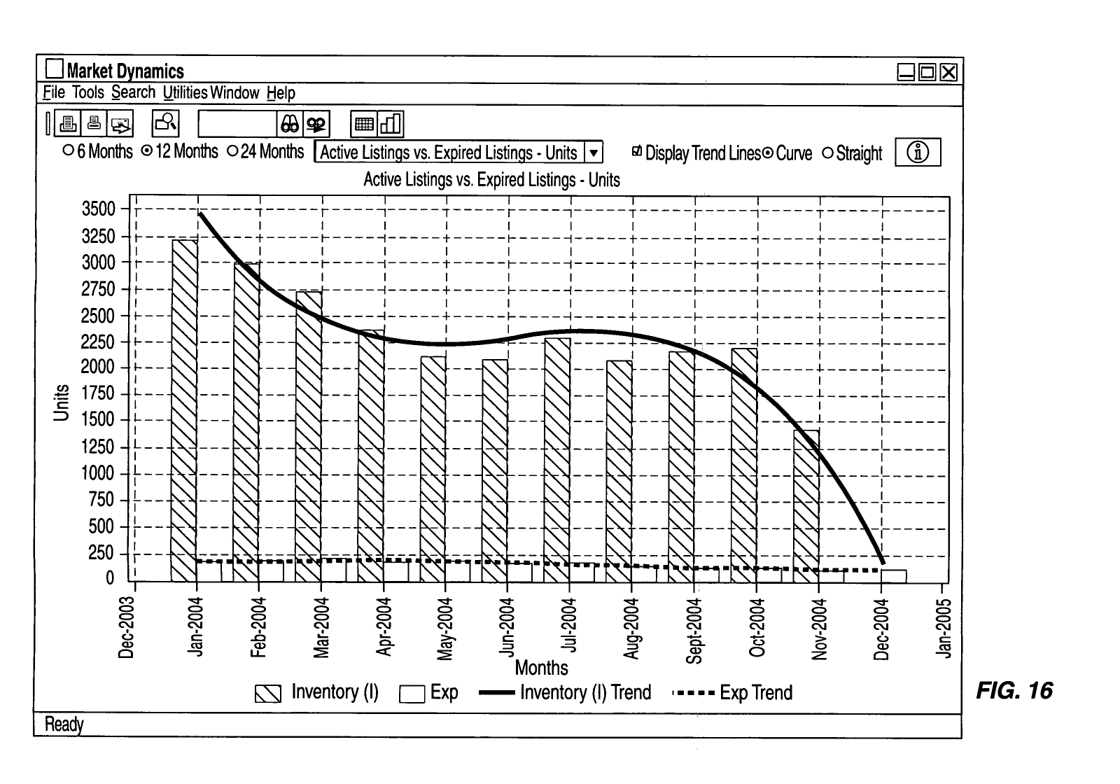

This view, depicted in FIG. 16, displays the number of active listings (properties for sale) compared with the number of expired listings (properties exiting the market due to non-existent price points) on a monthly basis. For any given set of property criteria this chart compares the number of properties that are currently for sale with the number that are exiting the market due to improper pricing on a month-by-month basis. The resultant information can be viewed from either a 6-month, 12-month (default) or Year-over-Year perspective. This chart depicts active inventory in relation to the number of inventory units that are poorly priced within any market segment on a month-by-month basis. Some generalized market conditions can be inferred from the directional movement of the underlying trend lines:

Downward—market strength is increasing. Both trend lines moving downward, over time, indicate a market that is increasing in strength due to fewer active listings for sale and not as many listings expiring due to price.

Parallel—market is in equilibrium. The trend lines running in parallel are an indicator of balanced market conditions.

Upward—market strength is decreasing. Both trend lines moving upward, over time, indicate a market that is decreasing in strength due to more active listings for sale and more listings expiring due to price.

### New Listings vs. Active Listings—Units

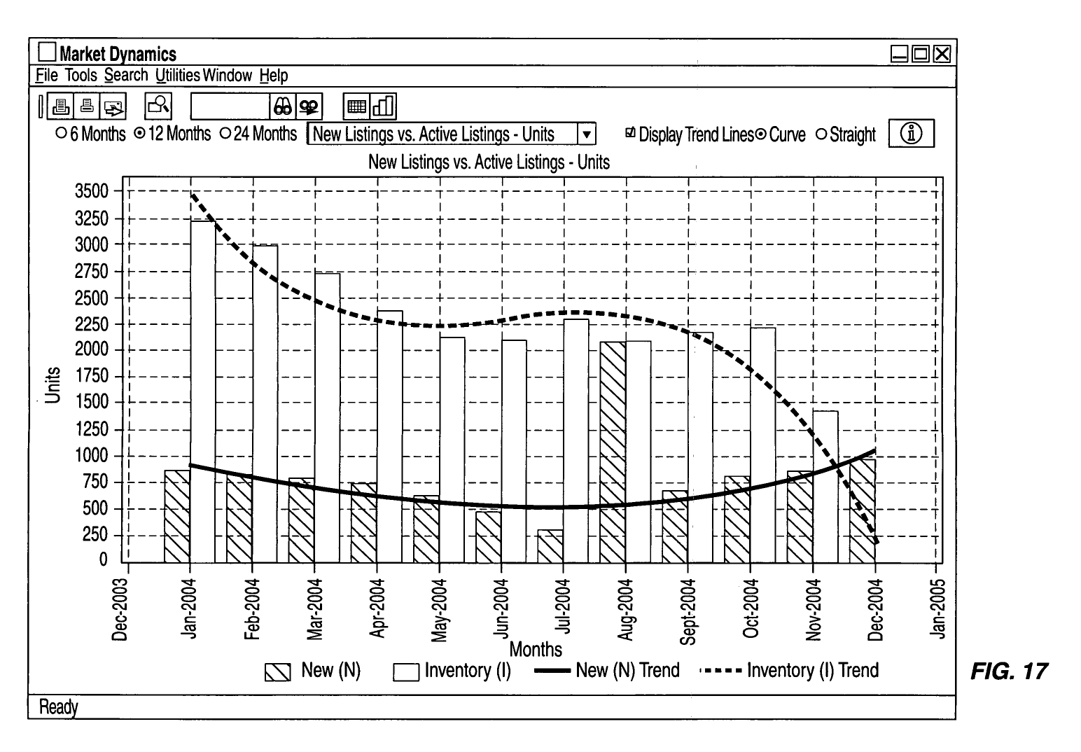

This view, depicted in FIG. 17, displays the number of new properties that add to the existing inventory on a monthly basis. For any given set of property criteria, this chart compares the number of properties that are currently for sale with the number of new listings that enter the market on a month-by-month basis. The resultant information can be viewed from either a 6-month, 12-month (default) or Year-over-Year perspective. The size (# of Active properties) and new activity (# of New Listings) of the market segment are depicted visually and thus easy to comprehend. Some generalized market conditions can be inferred from the directional movement of the underlying trend lines:

Downward—market strength is increasing. Both trend lines moving downward, over time, indicate a market that is increasing in strength due to fewer active listings for sale, i.e. supply is decreasing and inversely demand is increasing.

Parallel—market is in equilibrium. The trend lines running in parallel are an indicator of balanced market conditions.

Upward—market strength is decreasing. Both trend lines moving upward, over time, indicate a market that is decreasing in strength due to more active listings for sale, i.e. supply is increasing and inversely demand is decreasing.

### New Listings vs. Sold Listings—Units

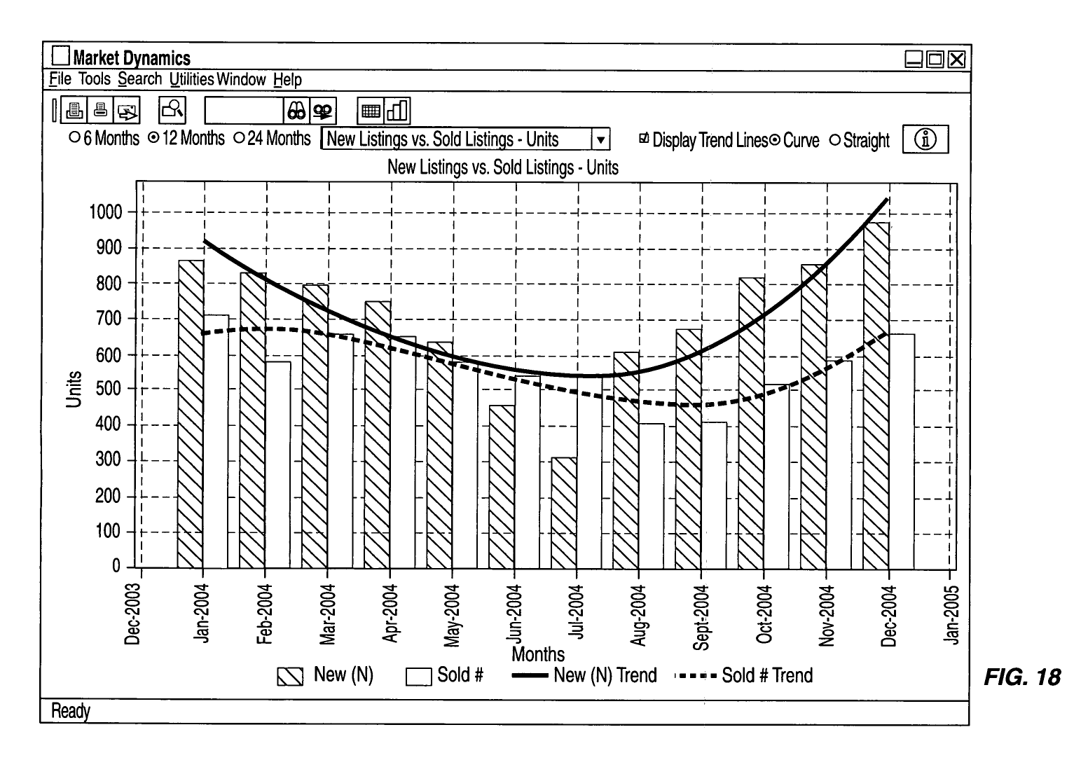

This view, depicted in FIG. 18, displays the number of new listings entering the market compared with the # of sold listings (properties successfully closing escrow) on a monthly basis. For any given set of property criteria this chart compares the number of properties that are incrementally adding to the existing inventory with the number that are exiting the market due to successfully closing on a month-by-month basis. The resultant information can be viewed from either a 6-month, 12-month (default) or Year-over-Year perspective. The incremental addition (# of new listings) to the market is compared with the incremental subtraction (# of closed escrows). The results are depicted visually and thus easy to comprehend. Some generalized market conditions can be inferred from the directional movement of the underlying trend lines:

Converging—market strength increasing. Trend lines converging indicate that supply (active listings) is decreasing while demand (sold listings) is increasing. These conditions, over time, tend to favor sellers.

Parallel—market in equilibrium. Trend lines moving in an approximately parallel manner indicate that supply (active listings) and demand (sold listings) are in equilibrium. This is indicative of balanced market conditions.

Diverging—market strength decreasing. Trend lines diverging indicate that supply (new listings) is increasing while demand (accepted offers) is decreasing. These conditions, over time, tend to favor buyers.

### Percentage: Accepted Offers to Active Listings

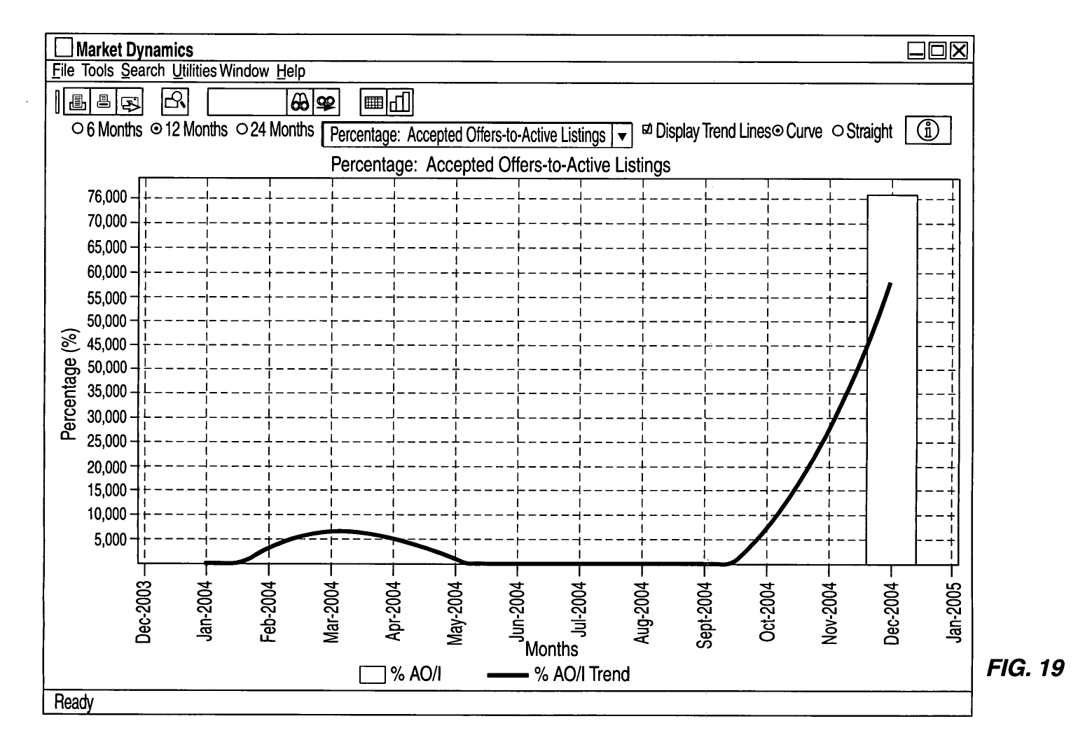

This view, depicted in FIG. 19, displays the percentage of listings that receive accepted offers on a monthly basis. For any given set of property criteria this chart depicts the percentage of properties within the inventory pool that receive accepted offers on a month-by-month basis. The resultant information can be viewed from either a 6-month, 12-month (default) or Year-over-Year perspective. This ratio is a direct measure of market conditions because it is measuring buyer demand on a monthly basis. Some generalized market conditions can be inferred from the directional movement of the underlying trend line:

Upward—market strength is increasing. The trend line moving upwards, over time, indicates a market that is increasing in strength due to increased buyer demand.

Parallel—market is in equilibrium. A parallel running trend line indicates steady, balanced market conditions.

Downward—market strength is decreasing. The trend line moving downwards, over time, indicates a market that is decreasing in strength due to decreased buyer demand.

### Active Listings—Median Price

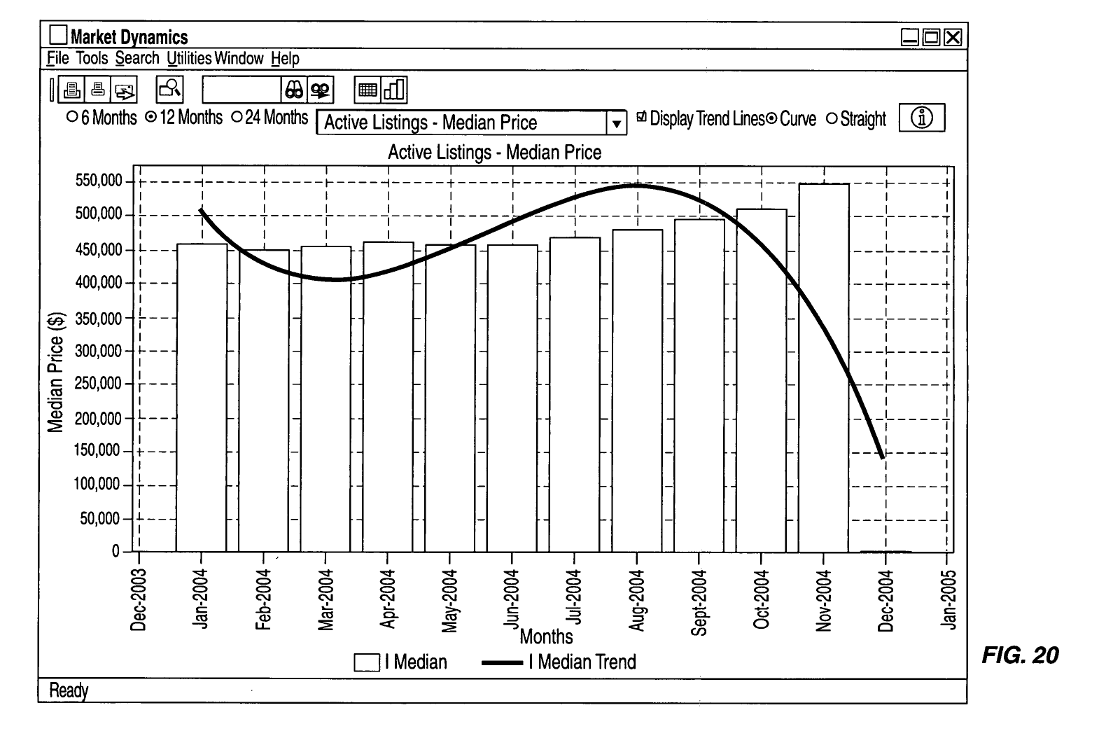

The view, depicted in FIG. 20, displays the median price of active listings measured on a monthly basis. For any given set of property criteria, this chart depicts the change in the median price of the inventory pool (active listings) on a month-by-month basis. The resultant information can be viewed from either a 6-month, 12-month (default) or Year-over-Year perspective. This is an indirect measure of market demand, i.e. rising prices generally indicate increased demand. Some generalized market conditions can be inferred from the directional movement of the underlying trend line:

Upward—market strength is increasing. The trend line moving upwards, over time, indicates a market that is gaining in strength due to increased demand putting upward pressure on prices.

Parallel—market is in equilibrium. A parallel running trend line indicates steady, balanced market conditions with prices remaining stable.

Downward—market strength is decreasing. The trend line moving downwards, over time, indicates a market that is decreasing in strength due to decreased demand putting downward pressure on prices.

### Accepted Offers—Median Price

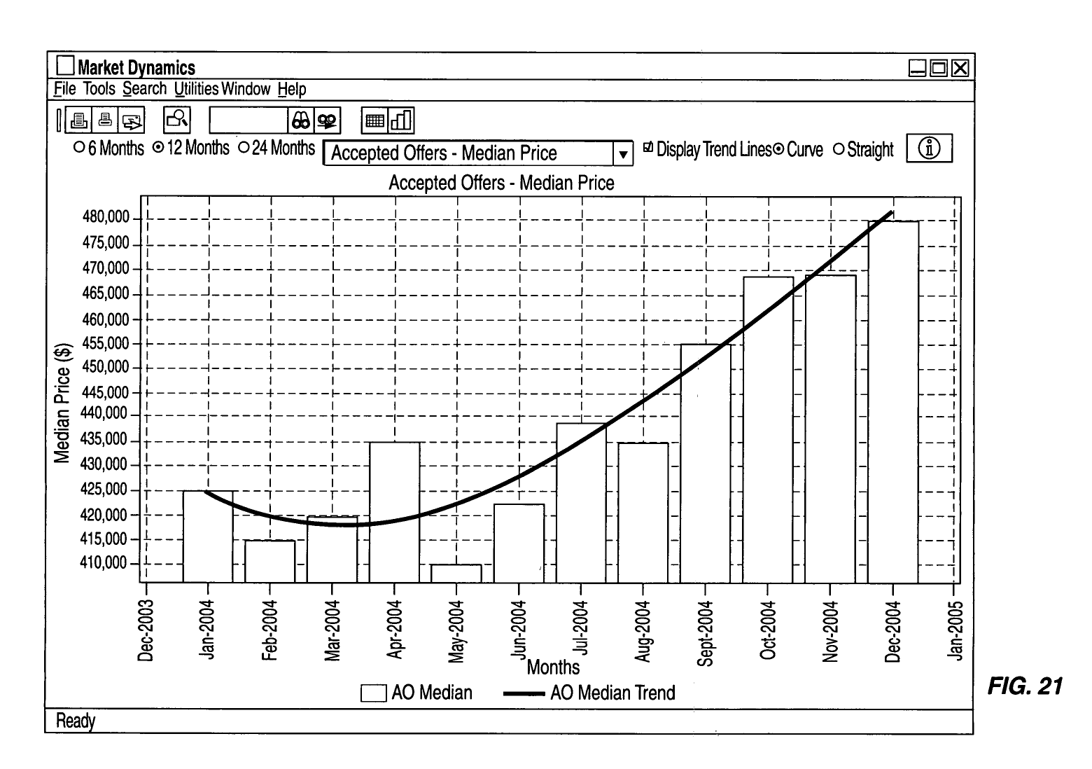

This view, depicted in FIG. 21, displays the median price of properties drawing offers measured on a monthly basis. For any given set of property criteria, this chart depicts the change in the median price of the properties drawing offers (accepted offers) on a month-by-month basis. The resultant information can be viewed from either a 6-month, 12-month (default) or Year-over-Year perspective. This is an indirect measure of market demand, i.e., rising prices generally indicate increased demand. Some generalized market conditions can be inferred from the directional movement of the underlying trend lines:

Upward—market strength is increasing. The trend line moving upwards, over time, indicates that the market is gaining strength due to increased demand generating upward pricing pressure.

Parallel—market is in equilibrium. A parallel running trend line indicates steady, balanced market conditions with prices remaining stable.

Downward—market strength is decreasing. The trend line moving downwards, over time, indicates that the market is losing strength due to decreased demand generating downward pricing pressure.

### New Listings—Median Price

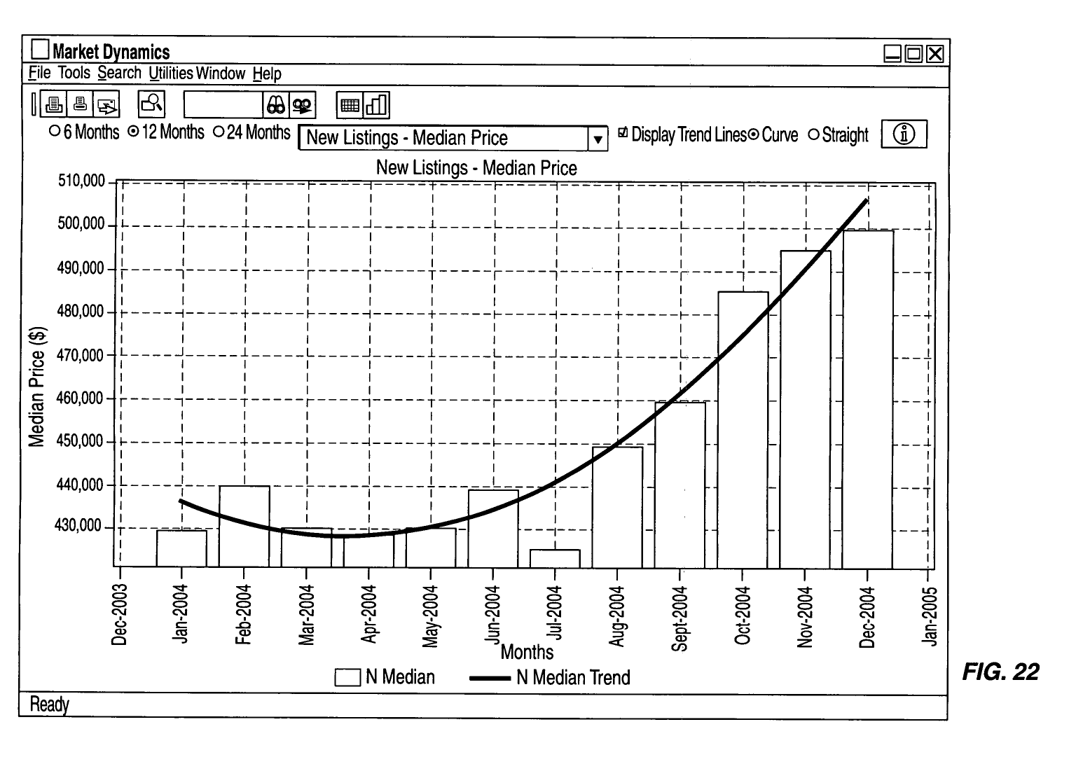

This view, depicted in FIG. 22, displays the median price of new listings entering the market measured on a monthly basis. For any given set of property criteria, this chart depicts the change in the median price of the properties drawing offers (accepted offers) on a month-by-month basis. The resultant information can be viewed from either a 6-month, 12-month (default) or Year-over-Year perspective. This is an indirect measure of market demand, i.e. rising prices generally indicate increased demand. Some generalized market conditions can be inferred from the directional movement of the underlying trend lines:

Upward—market strength is increasing. The trend line moving upwards, over time, indicates that the market is gaining strength due to increased demand generating upward pricing pressure.

Parallel—market is in equilibrium. A parallel running trend line indicates steady, balanced market conditions with prices remaining stable.

Downward—market strength is decreasing. The trend line moving downwards, over time, indicates that the market is losing strength due to decreased demand generating downward pricing pressure.

### Expired Listings—Median Price

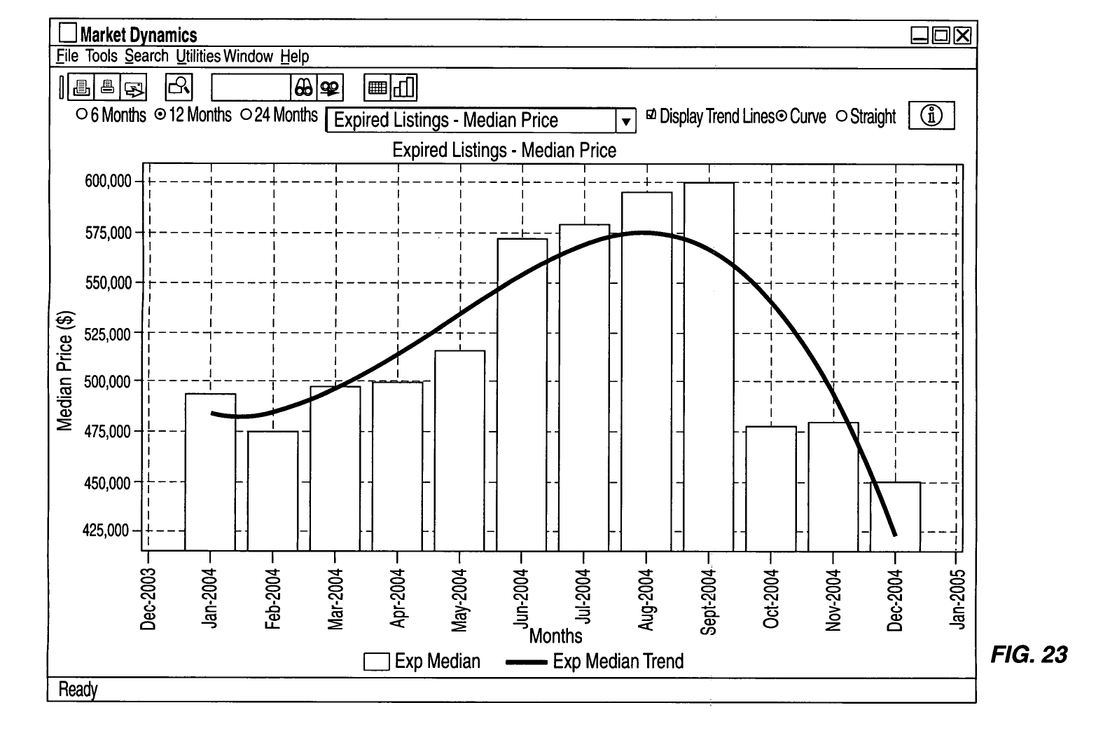

This view, depicted in FIG. 23, displays the median price of expired listings (properties incorrectly priced for market conditions) measured on a monthly basis. For any given set of property criteria, this chart depicts the change in the median price of the properties that failed to sell and exited the market on a month-by-month basis. The resultant information can be viewed from either a 6-month, 12-month (default) or Year-over-Year perspective. This is an indirect measure of market conditions because failed price points and buyer demand move inversely (opposite) to one another. Some generalized market conditions can be inferred from the directional movement of the underlying trend lines:

Upward—market strength is decreasing. The trend line moving upwards, over time, indicates that the market is losing strength because demand and hence “market-clearing” prices are falling. Thus, more properties are failing to sell and exiting at price points that reflect previous market conditions.

Parallel—market is in equilibrium. A parallel running trend line indicates steady, balanced market conditions with prices remaining stable.

Downward—market strength is increasing. The trend line moving downwards, over time, indicates that the market is gaining strength because demand and hence “market-clearing” prices are moving up. Thus, more marginally priced properties are selling rather than exiting the market.

### Combined (A, S, X)—Median Price

This view, depicted in FIG. 24, measures market demand from (3) different perspectives. For any given set of property criteria, this chart depicts the change in median prices of the active inventory (A), successfully closed properties (S) and those that failed to sell (X) on a month-by-month basis. The resultant information can be viewed from either a 6-month 12-month (default) or Year-over-Year perspective. Typically, “high” demand markets show upward movement of (A) & (S) with flat or downward movement of (X). Just the opposite is true of “low” demand markets.

### Pricing Analysis

The data mining, analysis and display features of one or more embodiments of the present invention provide a powerful tool and methodology for accurately and competitively pricing properties. In one embodiment, pricing begins with a search, selecting property types, area type, and bedroom/bathroom configurations corresponding to the property to be priced. Additional features, such as square footage, number of half baths, and year built, may optionally be included in the search. A suggested price is required.

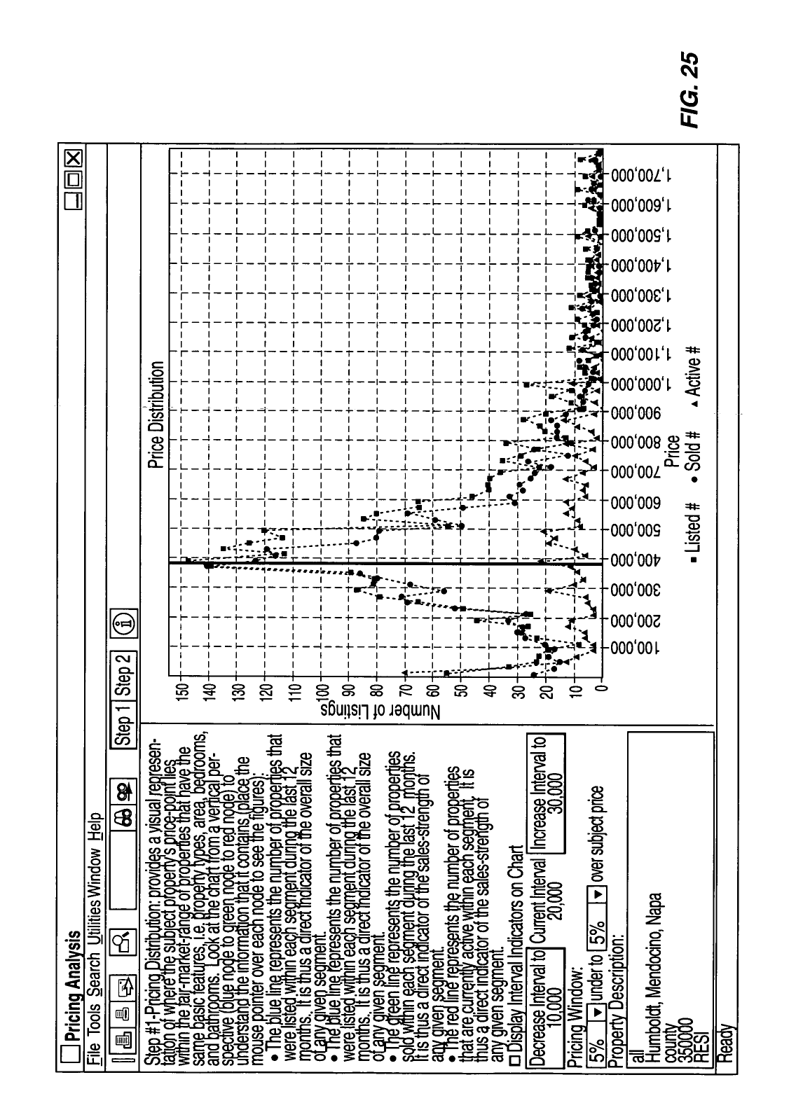

Following the search, a line graph of listed, sold, and active properties matching the search criteria over the previous 12 months may be displayed, with price as the units of the abscissa and number of listings as the units of the ordinate. This is depicted in FIG. 25. The suggested price of the target property may be displayed, such as by a vertical line. A price range above and below the price may also be displayed as a colored band surrounding the price line. The graph elements may be distinguished by color.

The graph “smoothness” may be adjusted by altering the resolution of the abscissa axis, or the horizontal interval over which the vertical data are calculated. This interval may be altered, such as by clicking “increase interval” and “decrease interval” buttons. This may alter the interval by a fixed amount, such as $10,000. Additionally, the price range surrounding the suggested price may be increased or decreased, such as by selecting percentages of the suggested price from a drop-down list. In one embodiment, the ranges above and below the suggested price are independently adjustable.

The graph provides a visual representation of where the subject property's price-point lies within the fair-market-range of properties that have the same basic features, i.e., property type, area, bedrooms and bathrooms. The user should look at the chart from a vertical perspective to understand the information it contains. Placing the cursor on any line at any point will may display a numeric value.

The plot of listed properties depicts the number of similar properties that were listed within the last 12 months. This plot is thus a direct indicator of the overall size of the market segment.

The plot of sold properties represents the number of properties in the market segment that sold within the last 12 months. It is thus a direct indicator of the sales strength of the market segment.

The plot of active properties represents the number of properties that are currently actively listed within the market segment. It is thus an indicator of the competition that will be faced by any new listing coming into the market within the sector.

An ideal situation—indicating a proper pricing—would be for the listed and sold plots to be very high (preferably peaking at the target price), indicating a large market with many sales for properties matching the subject property's attributes, and for the active plot to be very low at the target price, indicating a small supply of similar properties on the market.

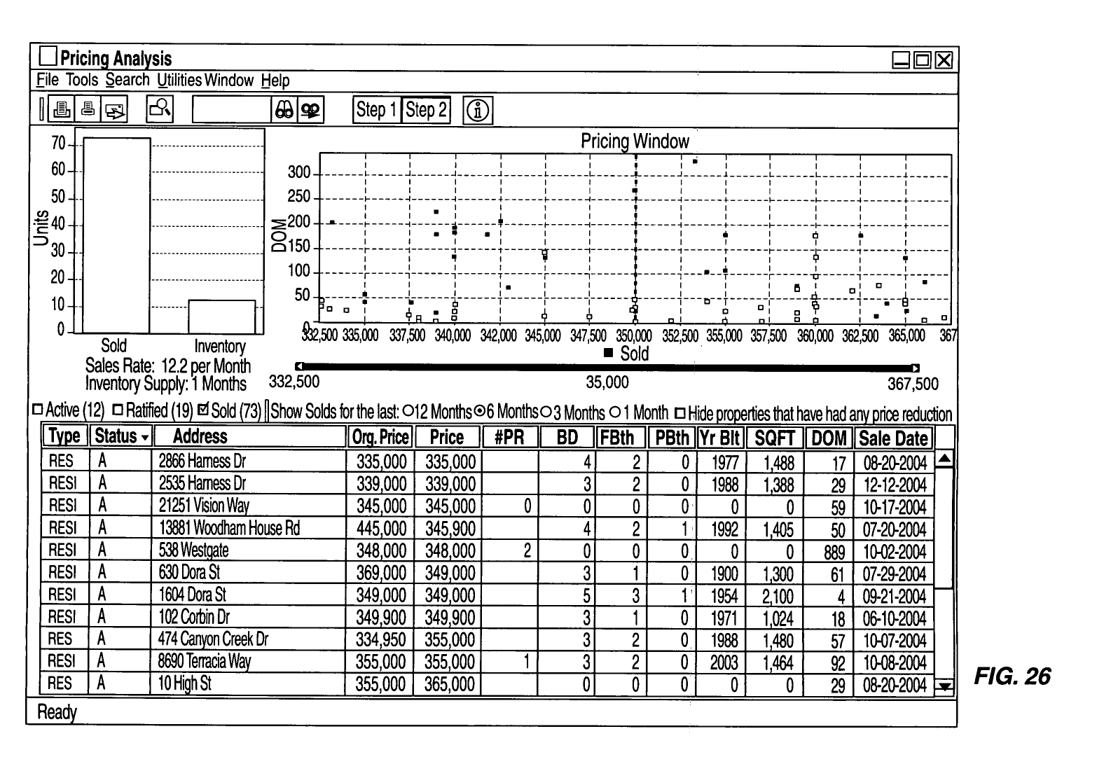

Once the overall market strength relative to the suggested price for a particular market segment has been assessed, a second step in the Pricing Analysis according to one embodiment is to present a detailed pricing view, as depicted in FIG. 26. The detailed pricing view comprises, for example, a graph depicting the sales rate and MSI (month's supply of inventory), such as in a bar graph, as well as numerically.

According to one embodiment, a novel display that facilitates accurate pricing is a graphical display of properties within the predefined range of the suggested price (the colored band around the vertical line in the graph of FIG. 25), within the defined market segment (type, area, etc). The abscissa units are price, and the ordinate units are DOM. The active, ratified, and/or sold properties within this price range may be displayed as data points on a scatterpoint graph, distinguished by symbol and/or color. In particular, a property that has been re-priced may be displayed as a solid symbol, and a property that has not undergone any change in price may be displayed as an open or hollow symbol. This indicates at a glance those properties that are attempting to “find the market” by adjusting their asking price.

Overall, the scatterpoint graph indicates the concentration of properties around various price-points, how many have been re-priced, and how long they have been on the market. In one embodiment, this re-pricing information is maintained in a local database that is updated periodically (e.g., daily) from the MLS. While the MLS typically only retains the current and most-recent price, the local database may retain pricing over the history of a particular property's listing. Thus, the display of FIG. 26, in addition to its unique value as a visual indicator of pricing in the defined market, may be more accurate than the MLS by displaying data that are more complete. The data may be selected, such as via radio buttons, between a variable time frame, such as the past 1, 3, 6, or 12 months. The suggested price may be indicated as a vertical bar. Additional vertical bars may indicate predetermined time durations, such as 30, 60, and 90+ days on market. These bars may be color-coded for easy reference. The range and number of properties displayed may be controlled by a double-ended slider bar. A check box may allow the user to remove from the display any properties that underwent price reductions, thus displaying only the most “well-priced” properties for comparison.

In one embodiment, a tabular display of the properties in the price range is also displayed, and linked to the graphic display by mouse-over/highlighting. The tabular display presents, one property per row, one or more of: the property type; status code; address; original and current price; number of price reductions; information such as number of bedrooms, bathrooms, year built and the like; DOM; and sale date. In one embodiment, by clicking on a table entry, the table row display changes to an italicized font, and the corresponding point is removed from the tabular display totals and from the scatter plot. This allows an agent to remove a property from the comparison for some reason, while still acknowledging and accounting for it.

Particularly for residential properties, the importance of initial pricing is paramount. Properly priced properties sell quickly. Improperly priced properties incur unnecessary effort and expense to sell. The Pricing Analysis tool is a powerful tool for agents, allowing them to price properties at points that will sell quickly, based on a solid analysis of fresh (e.g., daily), actual listing and sales data in the relevant market sector. The Pricing Analysis tool presents the results of sophisticated analysis in unique, powerful visual formats that allow those knowledgeable in the market to quickly grasp and interpret the results, to properly price subject properties. Additionally, the Pricing Analysis tool is a powerful sales aid for agents to secure new listings, by demonstrating professionalism, expertise and a solid command of the real estate market.

### Real Estate Business Management

One or more embodiments of the present invention may be utilized as an integral part of a method of business management for real estate businesses. The primary method steps are outlined below.

Management must allocate sufficient time and cerebral effort to understand “how-and-why” key metrics are identified and then measured and monitored over time. There needs to be an appreciation of the power that real-time, clear, concise and meaningful information (presented visually) can bring to the day-to-day decision making process.

Management must comprehend the meaning of each (efficiency) metric so that the variables of “beneficial” change are well understood. They must understand the causal relationships behind performance (e.g., C/L) so they can manage “what matters,” communicate the appropriate message throughout the entire organization, and lay the foundation for performance improvement going forward.

Management must grasp how all three levels of aggregation are interrelated and work together as a whole so that the company can set goals and execute a plan to achieve them across the entire organization.

Management must document a clear-cut strategy for achieving these goals and objectives. The relationship between the efficiency metrics and the performance activities that affect them must be clearly delineated. Once management has determined which activities will provide the most cost effective and beneficial mix, they must communicate this message throughout the organization via the visual communication capabilities of software according to one or more embodiments described herein.

Once a clear-cut strategy is in place, management must turn it into discrete plans of action so that these positive changes can be made. For example, an increased understanding of how performance drivers and efficiency metrics relate may lead to decisions on what activities should be performed and concentrated on to effectuate such change (e.g. to improve the company T/L ratio activities must be performed that produce more buyers—open houses, direct mail to renters, etc.). The real-time information can provide insights into past and current performance so that realistic, attainable goals can be set. Once these goals are input into the applications according to one or more embodiments they will instantly be communicated to everyone in the organization.

Management must then monitor progress towards compliance with the stated goals and objectives. It is this process that fosters accountability and promotes progress because everyone knows where they stand and what activities they need to do to meet expectations. Each tool set provides the user with a real-time, visual display of their efficiency metrics so that they can determine whether their current activities are in alignment with company objectives. Thus, any necessary course corrections can be made “sooner rather than later.”

When the plan has been successfully executed and compliance achieved the beneficial results can be calculated within applications according to one or more embodiments. The “What If” functionality can display the results of different scenarios from actual results so that the financial benefits of the plan can be determined in relation to the cost of implementation.

### Method of Discovering and Recruiting Talent

As one example of the power of the data mining, analysis, and presentation of MLS data to benefit a real estate business, consider the perpetual challenge of finding and recruiting the key to a successful office—efficient, productive agents (or alternatively, recruiting office managers by an enterprise). Typically, agents and brokers are recruited based on their reputation, and/or they may market themselves by selective and tendentious manipulation of listing and sales data that may obscure efficiency factors (such as large DOM, excessive price reductions, many expired or withdrawn listings, and the like). Using the sophisticated tools according to one or more embodiments described herein, an office manager may access all actual data regarding any agent's listing and sales activities, and evaluate that agent's efficiency and productivity metrics against the office's own goals. In other words, the manager may analyze the agent's performance as if he or she had been “on board” for the past year, rating the agent vs. the office's own performance goals. This thorough, objective analysis against the office's metrics and goals may reveal those agents worth recruiting, and additionally may inform the manager as to compensation or other incentives, based on the “strength” of the candidate's proven performance.

The recruiting search begins with a special search that includes production and efficiency metrics. This search may be accessed, for example, from an office level Agent Performance—Recruiting option. The user supplies search criteria, similarly to the office level Market Share and Market Dynamic analyses (e.g., listing type, property type, area type, date range and price range). The search window allows the specification of additional metrics. These include Minimum Count and Minimum Volume for the specified time frame (YTD, QTD, MTD, last 6 or 12 months, or user-defined period by start and end date). The user may also specify as search criteria, efficiency metrics for the previous 12 months, including Minimum C/L, Minimum T/L and Maximum AMT.

Once the search completes, a tabular Overview is displayed, listing one agent per row, and including information such as one or more of: numerical rank; agent name; inventory and total transactions by number and dollar volume; SOC %; C/L; T/L; AMT; DE %; PR/L % and SP/OP. The office's own agents and broker-agents are highlighted, and may be omitted from the display, such as by selecting a “hide my agents” check-box and/or a “hide broker-agents” check-box. The user may dive down to retrieve information related to either the agent's office or the agent, such as by right-clicking on the relevant row and selecting the appropriate option from a pop-up menu. The agents may be sorted by the contents of any column.

The office manager may then utilize the Agent Performance views, including the Inventory, Production, Measure and Monitor views described hereinabove, to analyze any agent's activity over a preceding time period. Generally, each view presents an Agent Grid listing the agents identified by the search, one per row, by numeric rank and agent name. Selecting any agent then populates the associated view display(s) with that agent's data. The Inventory, Production, Measure and Monitor views displayed for the selected agents are directly analogous to those with which the office manager is familiar, through both his monitoring of his own office with the corresponding office level views, and monitoring his agents via the Agent Performance views. In fact, the Agent Performance—Recruiting views are preferably identical to the Agent Performance—My Agents views. The only difference is the data being extracted from the MLS database 16. In the former case, the user is extracting data for all agents in the defined market segment; in the latter case, the user is extracting data only for his own agents.

### Advantages of the Various Embodiments of the Present Invention

The present invention, according to one or more embodiments thereof, represents an entirely new level of business intelligence and performance management tools for the real estate industry. Disparate data available to brokers may be aggregated and turned it into clear, concise and meaningful information that is quickly and readily absorbed, and can be used at every level of the organization to affect outcomes. Over time, this may result in enhanced efficiency and improved performance, two of the prerequisites for positive change. Thus, the probability of achieving the company's long-term goals and objectives increases.

A real estate business may better improve its strategic planning and execution processes. All critical decision-making information is presented on a real-time basis, removing the “timeliness-of-information” problem of prior art systems.

The ability to clearly communicate the company's goals, objectives and expectations to management is provided, so that their everyday decisions can be more clearly aligned with strategy. In addition, the dissemination of the company's goals, objectives and expectations to every member of the organization, in a highly visual manner, is facilitated, so that everyone clearly understands where they are and what they need to do to meet expectations.

The company's command and control structure is enhanced through its visual presentation of information. Each individual has a new appreciation of how their role can affect the company as a whole.

Increased performance is possible by providing the measuring and monitoring tools that allow past and current operating metrics to become “visible” so that all members of the organization have the ability to spot trends, identify opportunities and affect outcomes.

The steady stream of information allows senior management to continually stay abreast of market conditions, thereby, allowing strategic plans to stay dynamic and flexible. Thus, critical issues can be addressed in real-time and any problems that are revealed can be dealt with before they escalate.

Furthermore, the business may monitor compliance with company goals & objectives by this crucial link between strategy and implementation. Monitoring makes sure that the company's collective actions stay in line with its performance goals and objectives through measurement. Periodic measurement effectively reduces the uncertainty about the directional movements of the underlying “efficiency” metrics and allows this information to be incorporated dynamically into the planning process.

management may more easily set performance targets that are automatically disseminated to the entire company so that there is a common measuring stick in place. Thus, everyone knows where they are and what they need to do to meet expectations

The ability to convert voluminous amounts of performance data into simple and straightforward information, and present it in intuitive, highly visible ways enhances and simplifies managing the business. In effect, there is a continual stream of real-time business intelligence being delivered to the user's desktop.

The powerful data mining and analysis makes the invisible, visible, by revealing underlying patterns and relationships that are hidden within the data. Consequently, the user can spot trends and opportunities and turn them into actionable information that will help affect positive outcomes. Due to this informational leverage, every user can make better, more informed decisions, leading to improved efficiency and performance.

Both company-specific and total market information may be monitored so that performance improvements can be measured against both internal and external metrics.

All of these factors result in better and more predictable performance over time. The net result is that there is direct, measurable improvement to the bottom line.

Although the present invention has been described herein with respect to particular features, aspects and embodiments thereof, it will be apparent that numerous variations, modifications, and other embodiments are possible within the broad scope of the present invention, and accordingly, all variations, modifications and embodiments are to be regarded as being within the scope of the invention.

1. A method of data mining to support the management of a real estate business having a hierarchical management structure and including a plurality of units, comprising:
periodically extracting real estate data from one or more Multiple Listing Service (MLS) databases to a local database;
aggregating, at one or more hierarchical levels of said business, only said data that is associated with properties listed or sold by said real estate business; and
displaying said data, on an ad hoc basis, in a consistent manner across said levels.

2. The method of claim 1 wherein periodically extracting real estate data from one or more Multiple Listing Service (MLS) databases to a local database comprises extracting said data at least daily.

3. The method of claim 1 further comprising:
analyzing data associated with one unit of said business to generate at least one performance metric; and
displaying said at least one performance metric.

4. The method of claim 3 wherein said unit comprises said real estate business.

5. The method of claim 3 wherein said unit comprises a regional division of a real estate enterprise.

6. The method of claim 3 wherein said unit comprises an office of a real estate enterprise.

7. The method of claim 3 wherein said unit comprises a real estate agent within a real estate office.

8. The method of claim 3 wherein said performance metric is the ratio of the number of successfully closed transactions by said unit to the number of listings by said unit.

9. The method of claim 3 wherein said performance metric is the ratio of the number of successfully closed listings by said business to the number of listings by said business.

10. The method of claim 3 wherein said performance metric is the average time spent marketing each listing taken by said business, whether or not the listed property sells.

11. The method of claim 3 wherein said performance metric is the ratio of net income to gross revenue generated by said business.

12. The method of claim 3 wherein displaying said performance metric comprises displaying a graphic representation of the difference between said performance metric and predetermined value.

13. The method of claim 3 wherein displaying said performance metric comprises displaying a graph depicting values of said performance metric over a predetermined time period.

14. The method of claim 1 wherein displaying said data comprises displaying a graph of said data.

15. The method of claim 14 wherein displaying said data additionally comprises displaying said data in a textual list, and wherein each entry in said list is linked to a corresponding element on said graph such that indicating a graph element highlights the associated list entry.

16. The method of claim 15 further comprising displaying detailed underlying data that is aggregated to said graph element or said list entry.

17. The method of claim 14 wherein said graph depicts active and accepted listings by said unit, with an ordinate representing the dollar volume of said listings and an abscissa identifying said units.

18. The method of claim 17 wherein said graph is a stacked bar graph.

19. The method of claim 14 wherein said graph depicts properties listed by said unit, with an ordinate representing price and an abscissa representing the amount of time the properties have been listed.

20. The method of claim 19 wherein said graph is a scatterpoint graph.

21. The method of claim 14 wherein said graph depicts list and sell side transactions by said unit over a predetermined time period with an ordinate representing the volume of said transactions and an abscissa representing predetermined time periods within said time period.

22. The method of claim 21 wherein said graph is a stacked bar graph.

23. The method of claim 22 wherein said graph optionally displays monthly listed volume as a line graph superimposed on said stacked bar graph.

24. The method of claim 22 wherein said graph optionally displays a trend line representing closed transactions over a predetermined time frame as a line graph superimposed on said stacked bar graph.

25. The method of claim 14 wherein said graph depicts list and sell side transactions by said units over a predetermined time period with an ordinate representing the dollar volume of said transactions and an abscissa identifying said units.

26. The method of claim 25 wherein said graph is a stacked bar graph.

27. The method of claim 14 wherein said graph depicts list and sell side transactions for a plurality of predetermined regions by said unit over a predetermined time period with an ordinate representing the volume of said transactions and an abscissa representing said regions.

28. The method of claim 27 wherein said graph is a stacked bar graph.

29. The method of claim 28 wherein said graph optionally displays a percentage associated with each stacked bar representing the percentage of the unit's listings in the associated region over said time period.

30. A method of analyzing real estate data for a real estate business unit, comprising:
periodically extracting real estate data from one or more Multiple Listing Service (MLS) databases to a local database;
analyzing only data from said local database that is associated with properties listed or sold by said real estate business unit; and
calculating and displaying the ratio of the number of successfully closed transactions by said real estate business unit to the number of listings by said real estate business unit.

31. The method of claim 30 further comprising calculating said ratio over a plurality of predetermined time periods, and displaying a historic view of said ratio.

32. A method of analyzing real estate data for a real estate business unit, comprising:
periodically extracting real estate data from one or more Multiple Listing Service (MLS) databases to a local database;
analyzing only data from said local database that is associated with properties listed or sold by said real estate business unit; and
calculating and displaying the average time spent marketing each listing taken by said business unit, whether or not the listed property sells.

33. The method of claim 32 further comprising calculating said average marketing time over a plurality of predetermined time periods, and displaying a historic view of said average marketing time.

34. A method of analyzing real estate data for a real estate business unit, comprising:
periodically extracting real estate data from one or more Multiple Listing Service (MLS) databases to a local database;
aggregating data from said local database;
displaying said aggregate data in a table or graph; and
upon selection of an aggregate data point in the form of a table entry or graph element, and execution of a predetermined input, displaying detailed underlying data comprising the aggregate data point selected.

35. A method of analyzing real estate data for a real estate enterprise, comprising:
periodically extracting real estate data from two or more Multiple Listing Service (MLS) databases to a local database;
extracting data from said local database and aggregating data across said two or more MLS databases; and
displaying said aggregate data in a table or graph.

36. A method of managing a real estate business comprising a plurality of units, comprising:
periodically extracting real estate data from one or more Multiple Listing Service (MLS) databases to a local database;
extracting from said local database data associated with properties listed or sold by said units;
displaying data associated with a first said unit in first display on a first terminal;
displaying a list of said units on a second terminal;
selectively displaying data associated with said first unit in a second display on a second terminal in response to a user selecting said first unit from said list, wherein said first and second displays display the same data in substantially the same way.

37. The method of claim 36, further comprising displaying data associated with a second said unit in a third display on a third terminal; and
in response to a user selecting said second unit from said list, displaying data associated with said second unit in said second display on said second terminal, wherein said third and second displays display the same data in substantially the same way.

38. The method of claim 36 wherein said units are selected from the group including regional divisions of a real estate enterprise, offices of a regional division of a real estate enterprise, offices of a regional real estate business, and real estate agents within a real estate office.

39. A method of ascertaining real estate market trends, comprising:
periodically extracting real estate data from one or more Multiple Listing Service (MLS) databases to a local database;
defining a market by selecting one or more property attributes, including MLS-defined geographic area;
on an ad hoc basis, extracting data associated with properties in said market from said local database;
analyzing said data associated with properties in said market to calculate predetermined market metrics; and
displaying at least one said market metric over a predetermined time period in a table or graph.

40. The method of claim 39 further comprising:
analyzing said data associated with properties in said market to determine trends in said metrics over said predetermined time period;
displaying a graph of at least one said market metric; and
optionally displaying a graph of a trend associated with at least one said displayed metric.

41. The method of claim 39 further comprising optionally displaying detailed underlying data that is aggregated to said graph upon selecting a graph element and executing a predetermined input.

42. The method of claim 41 wherein said graph of metrics comprises a bar graph depicting one or more said metrics over a predetermined time period and wherein said graph of trends comprises a line graph depicting trends associated with the metrics displayed in said bar graph.

43. The method of claim 39 wherein said one or more metrics are selected from the group consisting of
active listings and accepted offers by unit volume,
months supply of inventory by months and median days on market by days,
accepted offers to new listings by percentage,
median price sold by price and median days on market by days,
new listings and accepted offers by days,
active listings and expired listings by unit volume,
new listings and active listings by unit volume,
new listings and sold listings by unit volume,
accepted offers to active listings by percentage,
active listings by median price,
accepted offers by median price,
new listings by median price,
active, sold and expired listings by median price.

44. The method of claim 43 wherein said one or more metrics are selected from the group consisting of
active and sold listings by unit volume,
active listings and accepted offers by unit volume,
months supply of inventory by months and median days on market by days,
accepted offers to new listings by percentage,
median price sold by price and median days on market by days,
new listings and accepted offers by days,
new listings and active listings by unit volume,
new listings and sold listings by unit volume, and
accepted offers to active listings by percentage.

45. A method of evaluating a real estate agent not associated with a real estate business, comprising:
periodically extracting real estate data from one or more Multiple Listing Service (MLS) databases to a local database;
extracting data from said local database that is associated with properties listed or sold by said real estate agent over a predetermined time period;
analyzing said data against financial and performance metrics unique to said real estate business; and
displaying information estimating what said real estate agent's performance would have been within said real estate business over said time period.

46. The method of claim 45 further comprising calculating one or more performance metrics for a plurality of real estate agents including said real estate agent, and displaying an ordered list of said real estate agents ranked by one or more said performance metrics.

47. The method of claim 46 further comprising highlighting agents in said plurality of real estate agents that are associated with said real estate business.

48. The method of claim 47 further comprising removing from said list, selected agents that are associated with said real estate business.

49. The method of claim 46 wherein said performance metrics are selected from the group including
the ratio of the number of successfully closed transactions by each said agent to the number of listings by that agent,
the ratio of the number of successfully closed listings by each said agent to the number of listings by that agent,
the average time spent marketing each listing by each said agent, whether or not the listed property sells, and
the ratio of net income to gross revenue generated by each said agent.

50. A method of determining a listing price for a subject property, comprising:
periodically extracting real estate data from one or more Multiple Listing Service (MLS) databases to a local database;
obtaining one or more attributes of the subject property;
extracting from said local database properties having similar attributes;
displaying a graph depicting the number of said similar properties listed and sold over a predetermined time period, and the number of currently active listings of said similar properties.

51. The method of claim 50 wherein said graph includes an ordinate in dollars and an abscissa in number of listings, and further displays a vertical bar depicting the selling price of the subject property.

52. The method of claim 50 further comprising:
displaying a scatterpoint graph of said similar properties falling within a selectable range of the subject property price, said graph having an ordinate representing days on market and an abscissa depicting price.

53. The method of claim 52 wherein at least two visually distinctive data point depictions indicate whether or not a property has been repriced.

54. The method of claim 53 wherein said local database retains historical pricing information for each listed property beyond that periodically extracted from said MLS database(s), and wherein said historical pricing information is used to determine whether each said property has been repriced.

55. The method of claim 52 further comprising displaying data associated with properties in said scatterpoint graph in a textual list, wherein each entry in said list is linked to a corresponding point on said graph such that indicating a graph point highlights the associated list entry.

56. The method of claim 55 wherein upon selection of a property, said property is removed from said scatterpoint graph and is not included in other calculations.

57. The method of claim 52 wherein said abscissa axis is scalable and slidable.

58. The method of claim 52 further comprising displaying the number of sold and active properties in said scatterpoint graph as a bar graph having an ordinate representing unit volume.

59. The method of claim 52 further comprising calculating and displaying the sales rate per month and the month supply of inventory for properties in said scatterpoint graph.

60. The method of claim 52 further displaying on said scatterpoint graph a plurality of vertical lines demarking predetermined durations that the displayed properties have been on the market.

61. A method of assessing real estate market share, comprising:
periodically extracting real estate data from one or more Multiple Listing Service (MLS) databases to a local database;
defining a market by identifying attributes including MSL-defined geographic area;
defining competitors by identifying one or more real estate offices or brokers;
extracting from said local database, data associated with properties in said market that were listed or sold by said competitors;
calculating the relative share of said market held by each said competitor; and
displaying said share.

62. The method of claim 61 wherein calculating the relative share of said market held by each said competitor comprises calculating the current market share by sold or active listings over a predetermined time period.

63. The method of claim 62 further comprising exporting said market share data.

64. The method of claim 63 wherein exporting said market share data comprises exporting said market share data in a GIS-compatible format.

65. The method of claim 62 wherein displaying said share comprises displaying a graph having an ordinate depicting dollar or unit volume and an abscissa identifying said competitors.

66. The method of claim 61 wherein calculating the relative share of said market held by each said competitor comprises calculating a market share trend for at least one said competitor over a plurality of predetermined time periods.

67. The method of claim 66 wherein displaying said share comprises displaying a graph for said at least one competitor, said graph having an ordinate depicting volume and an abscissa identifying said plurality of predetermined time periods.

68. The method of claim 67 wherein said ordinate display is selectable between dollar volume, percent market share by dollar, unit volume and percent market share by unit.

69. A method of executing real estate analysis software on a terminal having an network connection, comprising:
upon loading, checking to determine if the software being loaded is the most current version available;
if the software is current, loading the software and accessing a local database containing real estate data extracted from one or more Multiple Listing Service (MLS) databases;
if the software is not current, updating the software prior to accessing said database; and
extracting and analyzing real estate data from said local database.
